(19) United States
(12) Patent Application Publication
(10) Pub. No.: US 2007/0016455 A1
(43) Pub. Date: Jan. 18, 2007

(54) Corporate-owned life insurance settlement computer system

(76) Inventors: Raymond B. Ryan, Darien, CT (US); Neil Holme, Newtown, CT (US)

Correspondence Address: PETER K. TRZYNA, ESQ., P O BOX 7131, CHICAGO, IL, 60680, US

(21) Appl. No.: 11/397,348

(22) Filed: Apr. 3, 2006

Related U.S. Application Data
(60) Provisional application No. 60/667,302, filed on Apr. 1, 2005.
(60) Provisional application No. 60/686,203, filed on Jun. 1, 2005.
(60) Provisional application No. 60/686,873, filed on Jun. 2, 2005.

(51) Int. Cl. G06Q 40/00

(52) U.S. Cl. 705/4

(57) ABSTRACT

A computer-aided method including: generating output with a computer system by processing input data and thereby producing at least one of the group including: an illustration including a party without an insurable interest in a life insured by a COLI (corporate-owned life insurance) policy, wherein the party receives an assignment of an interest in a policy benefit, a performance report of a transaction that corresponds to the assignment, and a forecast of at least one of earnings and cash flow of an assignor of the interest in the policy, and a forecast of cash flow of the party that receives the assignment, the forecasts using transaction experience data. In the method, the transaction may include a contribution of the policy to a Special Purpose Entity (SPE), the SPE having at least two investor/owners; the SPE performance report includes performance data corresponding to the owner of the policy; and the processing may include further producing at least one of the group including: a performance report of the transaction that includes performance data corresponding to at least one owner of the SPE, a forecast of a balance sheet of the SPE, a forecast of an income statement of the SPE, and a forecast of a cash flow statement of the SPE.

### I. TECHNICAL FIELD

The technical field is computers and data processing systems. Depending on the implementation, there is apparatus, a method for use and method for making, and corresponding products produced thereby, as well as data structures, computer-readable media tangibly embodying program instructions, manufactures, and necessary intermediates of the foregoing, each pertaining to digital aspects of corporate-owned life insurance settlement.

### II. DISCLOSURE

In the area of said technical field, representatively, consider a computer system (illustratively representing, for the sake of brevity, methods, articles of manufacture, transmitter, receiver, network implementations, etc.) structured to aid managing, in whole or part, an embodiment a corporate-owned life insurance settlement. The computer system can, for example, be structured (e.g., including programmed) to carry out the steps of: processing input data and thereby producing at least one of the group including: an illustration including a party without an insurable interest in a life insured by a COLI (corporate-owned life insurance) policy, wherein the party receives an assignment of an interest in a policy benefit, a performance report of a transaction that corresponds to the assignment, and a forecast of at least one of earnings and cash flow of an assignor of the interest in the policy, and a forecast of cash flow of the party that receives the assignment, the forecasts using transaction experience data. In the method, the transaction may include a contribution of the policy to a Special Purpose Entity (SPE), the SPE having at least two investor/owners; the SPE performance report includes performance data corresponding to the owner of the policy; and the processing may include further producing at least one of the group including: a performance report of the transaction that includes performance data corresponding to at least one owner of the SPE, a forecast of a balance sheet of the SPE, a forecast of an income statement of the SPE, and a forecast of a cash flow statement of the SPE.

### III. BRIEF DESCRIPTION OF THE DRAWINGS

FIG. 1 is a block diagram of an exemplary computer system, linked to a system administrator's computer system which in turn, is linked to computer system(s) of one or more of the following: a Settlement Investor (which may be a trust or partnership to aggregate policies), a Broker-Consultant, a Life Insurance Carrier or other Underwriter(s), an Actuarial Consultant(s), the COLI Owner, and a System Administrator.

FIG. 2A is a block diagram illustrating an overall view of a representative embodiment of the Transfer Module.

FIG. 2B is a block diagram illustrating an overall view of a representative embodiment of the Administrative Module.

FIG. 3A is a listing and an overall view of the data collected and processed with respect to a COLI life insurance contract

FIG. 3B is a listing and overall view of the representative data collected and processed with respect to an insured life in a COLI program.

FIG. 3C is a listing and overall view of the representative data collected and processed with respect to deceased life previously insured by a COLI program.

FIG. 3D is a listing and overall view of the representative data collected and processed with respect to an owner of a COLI policy or policies.

FIG. 3E is a listing and overall view of the representative data collected and processed with respect to a settlement investor participating in a split ownership plan for COLI.

FIG. 3F is a listing and overall view of the representative data collected and processed with respect to a policy included as a part of a split ownership plan for COLI.

FIG. 3G is a listing and overall view of the representative data collected and processed with respect to miscellaneous sources of information included as a part of a split ownership plan for COLI.

FIG. 3H is a listing and overall view of the representative data collected and processed with respect to SOP and SPE plan structures.

FIG. 4A is a block diagram illustrating the process of creating investor criteria to be used to identify qualified acquisitions of COLI policies.

FIG. 4B is a block diagram continued from FIG. 4A.

FIG. 5A is a block diagram illustrating the computation of a SPE proposal and storing the same in the computer memory.

FIG. 5B is a block diagram illustrating the computation of a sale proposal and the storing of the same in the computer memory.

FIG. 5C is a block diagram illustrating the computation of a SOP proposal and the storing of the same in the computer memory.

FIG. 6A is a block diagram illustrating the recording of plan specific mortality experience and updating the system's mortality rate table and a plan specific mortality rate table.

FIG. 6B is a block diagram illustrating the computation of Life Expectancy (“LE”) for a selected mortality rate table and rounding of values to whole integers.

FIG. 7 is a block diagram with the steps to compute a COLI plan base case projection.

FIG. 8A is a block diagram illustrating the computation of a proposal illustration for a SOP under a given set of assumptions.

FIG. 8B is a block diagram illustrating the computation of a proposal illustration for a SPE under a given set of assumptions.

FIG. 9 is a block diagram illustrating the process of capturing and tracking deaths for plans that enter into an SOP assignment or an SPE contribution of a policy.

FIG. 10A is a block diagram illustrating the process of updating system tailored mortality tables using experience of SOP and SPE plans.

FIG. 10B is a block diagram illustrating the process to compute life expectancy.

FIG. 11A is a block diagram illustrating the process to record data and structure at a plan's inception.

FIG. 11B is a block diagram illustrating the process to report the status of purchased policies.

FIG. 11C is a block diagram illustrating the process to report the status of a SOP program.

FIG. 11D is a block diagram illustrating a continuation of the process to report the status of a SOP program.

FIG. 11E is a block diagram illustrating a continuation of the process to report the status of a SOP program.

FIG. 11F is a block diagram illustrating the process to report the status of a SPE plan.

FIG. 12A is a block diagram illustrating the process to initiate of forecast portion of the system.

FIG. 12B is a block diagram illustrating the process to forecast the performance of purchased policies.

FIG. 12C is a block diagram illustrating the process to forecast the performance of a SOP program.

FIG. 12D is a block diagram illustrating the process to forecast the performance of a SPE plan.

### IV. MODES

The accompanying drawings illustrate embodiments intended to illustrate and exemplify in a teaching manner.

As used herein, the term “computer” generally refers to hardware or hardware in combination with one or more program(s), such as can be implemented in software. Computer aspects can be implemented on general purpose computers or specialized devices, and can operate electrically, optically, or in any other fashion. A computer as used herein can be viewed as at least one computer having all functionality or as multiple computers with functionality separated to collectively cooperate to bring about the functionality. Note that the Figures herein teach with respect to a computer system, but it should be explicitly understood that such system may, depending on the embodiment preferred, be parsed into one system for illustrations, one system for reports, and one for forecasts; and parsed otherwise, e.g., with one entity communicating via its respective computer system. Logic flow can represent signal processing, such as digital data processing, communication, or as evident from the context hereinafter. Logic flow or “logic means” can be implemented in discrete circuits, programmed computer, or the equivalent. Computer-readable media, as used herein can comprise at least one of a RAM, a ROM, A disk, an ASIC, and a PROM. Industrial or technical applicability is clear from the description, and is also indicated below.

As used herein, “embodiment” should not be construed as the sole manner, but rather as an illustrative teaching, much as though teaching mathematical addition does not require setting out every numerical combination to convey the concept extending beyond the teaching examples. And just as in teaching addition by examples, rather than by a table of permutations of numbers, it should be understood that the teaching herein embraces all combinations from any embodiment incorporated into another, etc. so as to utilize the full breadth of the teaching herein. Note that mention herein to an embodiment to teach with respect to one statutory class of invention is intended to correspondingly teach another class of invention, so for example, a method (e.g., of using) is explicitly intended to comprehend method of making, apparatus, data signals (including necessary intermediates such as trigger signals and transmission/reception signals), a program on a disk or other computer-readable media, and corresponding articles of manufacture, etc.

By way of the following prophetic teaching, there can be computer support, as in a data processing system, for implementing parts of, or from, a financial product or instrument to accomplish certain financial objectives to and advance such as efficiency and/or security, over said manual systems and corresponding problems, and automated variants having limitations regarding management of corresponding computer resources. A management system of such a system can comprehend a menu or other means for human/machine interaction so as to carry out the functionality of an embodiment.

In one embodiment, there can be a computerized system that uses historical or current data, policy terms, and/or industry data to project the future actuarial and corresponding financial performance of certain life contracts on insured lives and/or groups of insured lives within a Corporate Owned Life Insurance (“COLI”) plan held by a business. (For purposes of this application, COLI shall be a life insurance policy held by a business or not-for-profit organization. A business entity can be a “C” corporation, a “Subchapter S” corporation, a limited liability corporation or LLC, a partnership, a trust, or other business entity.) Based on the information displayed in the system projections, settlement investors can make informed investments in COLI contracts.

In another embodiment, there can be a computerized system that uses mortality tables (“COIs”) to compute the Life Expectancy (“LE”) for a group or groups of lives insured under a COLI program. The more a settlement investor has confidence in the LE used by the system (instead or relying on the carrier or other third party's assumption), the more confidence the settlement investor has in achieving its projected system returns.

In another embodiment, there can be a computerized system that models the financial benefits to the COLI owner and the settlement investor that arises from a Split Ownership Plan (“SOP”). A SOP occurs when a COLI owner collaterally assigns a portion of the death proceeds of its policies to a settlement investor. The assignment does not change the legal title to the contract As part of the assignment agreement, the settlement investor is obligated to pay some or all of the premium obligation due on the policy. Generally, the value of the assignment is a function of the net amount at risk in a policy over the remaining LE. The amount of annual premium payments from the settlement investor is determined by the assignment value, the LE and investment return objectives of the settlement investor.

In addition, an embodiment occurs when the computerized system aggregates a group or groups of policies in an SOP program and prepares aggregate the financial projections for both of the participants in the SOP—the COLI owner and the settlement investor.

Also, the system can be used to prepare a comparison of alternative bids, where more than one settlement investor makes an offer.

Another embodiment includes a computer system administering policies subject to a SOP and administering purchased policies from a settlement transfer. As may be desired, part of the system administrative process can be made to develop insured group specific mortality tables from mortality experience of SOP policies and policies owned by settlement investors. In addition, the system design accepts third party mortality tables with—the expectation of embedding COLI experience tables from actuarial sources. System access to said mortality tables will enable existing settlement investors to update projected investment returns from purchases and SOPs as well as provide ever increasing accurate mortality input for future purchases or SOP transactions. A further embodiment of the system's tracking and reporting capability permits broker(s) for settlements and/or SOPs to align their compensation with that of the settlement investor(s) and receive their compensation in whole or in part via the distribution of death proceeds and/or annual policy charges.

For a business with a COLI plan that is no longer relevant and/or profitable, such embodiments create an exit strategy that previously not available. Where desired, an embodiment can be made to model multiple sales, SOPs and policy retention scenarios thereby enabling a COLI owner to design, select, and implement its preferred exit strategy. Also, as may be desired, an embodiment can enable a settlement investor in COLI purchases and/or SOPs to create an actuarial estimate of the cash flow from a group of COLI policies and/or SOPs. With performance expectations defined by the system, as may be preferred, the settlement investors can determine a premium to pay and stay within the boundaries of their desired rate of return on their COLI acquisition. Similarly, using performance expectations, the system can compute the amount of premium contributions that the settlement investor is prepared to pay under a SOP assignment.

Also, an embodiment can address the situation where a COLI program involves policies which are classified as Modified Endowment Contracts (“MEC”) by the Internal Revenue Code. The typical MEC contract calls for a single premium payable and has high ratio of policy cash value divided by policy gross face. Said differently, the policy net amount at risk is small in comparison to the policy cash value. MEC policies are taxed differently than regular contracts. For a corporate policy owner, a policy surrender or sale triggers a 10% penalty tax in addition to the normal corporate tax on surrender gains. Policy withdrawals are treated as taxable income to the extent that the policy cash value exceeds the tax basis of the policy. Banks and Savings & Loans are the principle owners of COLI in the MEC form (Bank Owned Life Insurance or “BOLI”).

An embodiment can compute an expected mortality date of each member of a group of insured lives without individual underwriting. For each COLI plan, the system may project mortality using original group census data and the deaths of plan participants since inception. Depending on the group size and period the COLI plan has existed, the system may be asked to prepare a companion projection of a mortality using one or more mortality tables embedded in the system. Based on the number of lives insured in the COLI plan, the length of time that the plan has been in existence, and the death experience in the COLI plan, the projected individual plan mortality may be supplemented with the mortality from the system's embedded mortality tables. With actuarially sound mortality forecasts, settlement investors can price a COLI purchase (or identify acceptable SOP terms). In fact, the more COLI policies settlement investors buy (or contract under SOPs) via this system, the law of large numbers will increase the probability that their purchased policy holdings will perform—in the aggregate—as predicted.

The system can be important to the COLI owner. Normally, after a number of years COLI's cash value is much greater than its tax basis. In this instance, a policy's surrender will generate a gain taxed at ordinary income tax rates. The book (“GAAP”) surrender gains pre-tax is zero. Under GAAP, a policy's book basis equals the policy's cash surrender value. Since the companies rarely accrue for a tax on the policy cash value build-up, any tax due on a surrender becomes a book current period expense. This GAAP tax expense often stops the COLI owner's policy surrender consideration. Public companies are pressured to sustain and increase their book earnings. As a consequence, typically they avoid elective transactions which trigger a charge to their income statement. This situation is referred to as the COLI “GAAP Trap” by the applicant.

Where a COLI owner is a taxpayer, it will be rare (if ever) that a sale generate sufficient revenue to make the transaction worthwhile. Outright sale opportunities will arise from COLI owners who are in a tax net operating loss position or are otherwise tax exempt. These COLI owners are motivated by current cash—and typically are not concerned with GAAP earnings. According tax exempt or COLI owners in a NOL, need to determine if they can sell one or more of their policies for an amount in excess of the surrender value (net of policy loans and accrued interest). An embodiment of the system computes a rate of return on the policy at a LE selected from the system. The policy owner can use that rate to compare to current settlement market rates to determine if a sale is possible. Next, using an investor target rate of return, system will compute the addition income presumably payable by a settlement investor. Similarly, the settlement investor can use the system to computer the amount payable with a selected LE and target return.

From the COLI owner's perspective, the system can enable settlement investors to bid with confidence for its policy acquisition(s). An otherwise illiquid asset now has a defined market where the COLI owner can obtain a price greater than what the policy underwriter will pay i.e., the cash surrender value. Almost as important, they will know which assets are eligible for sale both from the market's perspective and their own internal perspective.

Where a SOP structure is under consideration, the COLI owner will want a projection of share of death proceeds in each year the SOP is in force. The system can generate forecast(s) of expected allocated death proceeds and dates due the COLI owner. Each year this report can be re-issued to reflect the new age of the insured life and any changes to mortality assumptions. Also, system projections can reflect periodic book income, cash flow, book assets and liabilities of the COLI owner during its participation in a SOP transaction. With this system's data and forecasts, the COLI owner can make a fully informed decision regarding a proposed SOP and carefully track the results after executing the transaction.

Also, an embodiment can address the situation where a COLI program involves policies which are classified as Modified Endowment Contracts (“MEC”) by the Internal Revenue Code. The typical MEC contract calls for a first year one time premium payment and has high ratio of policy cash value to policy gross face. Said differently, the policy net amount at risk is small in comparison to the policy cash value. MEC policies are taxed differently than regular life insurance contracts. For a corporate policy owner, a policy surrender or sale triggers a 10% penalty tax in addition to the normal corporate tax on surrender gains. Policy withdrawals are treated as taxable income to the extent that the policy cash value exceeds the tax basis of the policy. Banks and Savings & Loans are the principle owners of COLI in the MEC form (Bank Owned Life Insurance or “BOLI”).

To implement a SOP like transaction for BOLI (a “SOP-MEC”), a Special Purpose Entity (“SPE”) is created. The typical business form of the SPE is a partnership. At inception, the bank contributes its BOLI and the settlement investor contributes bonds (or other property including cash) to the SPE. Pursuant to the SPE governing agreement, the typical allocation of income is for the settlement investor to receive the BOLI death proceeds and the bank to receive the income from the bonds (or other property). The return of corpus to the SPE participants is also specified by the SPE agreement. The bank is to receive the policy cash value at death and the investor is to receive the bond principal at its maturity. An embodiment provides a determination of the appropriate amount of investment by the settlement investor to achieve its financial goals and the corresponding consequences to the bank from participation in the SPE.

Due to its unique array of benefits to the COLI owner and to the settlement investor, SOP will dominate future investments in existing COLI. The system can prepare post-SOP projections of book income, balance sheet values, cash flow, and expected rates of return for the COLI owner and the settlement investor. Factors in this computation can include—pre SOP COLI projections, Life Expectancy (“LE”) for each insured life under the SOP, settlement investor's premium obligations and the settlement investor's share of death proceeds under the SOP. Again, these projections can be updated periodically to reflect refinements in LE, changes in the policy owner's financial attributes, and changes in the policy crediting and loan rates. With the above data and projections generated by the system, the settlement investor can also make an informed decision before entering into a SOP and carefully track the results after executing the transaction.

A further embodiment, as may or may not be desired in a given application, is the capability to administer the policies purchased by the settlement investor and/or policies held under a SOP. Prior hereto, settlement purchases were thought to be limited to small numbers of underwritten policies. Also, SOPs have heretofore not been offered to COLI owners. With pension plans and other institutional investors entering the settlement market as investors, it is useful to accurately account for the assets and/or intangible rights held and to properly report book income, book asset values, and cash flows. One embodiment herein includes the capability to track and to report policy book values and income as well as cash flow. In addition, the system design includes income tax reporting. Also, the system can aggregates policies and SOP interests held by a settlement investor. If a COLI plan has been sub-divided and bought by different settlement investors, the system can report the separate parts to the respective settlement investors. If a policy(s) is placed in a SOP(s), the system can provide the separate ownership interests with accurate accounting of the tax consequences, cash flow, and GAAP financials.

The system duplicates the same above array of benefits for an owner of BOLI and the settlement investor participating in an SPE which implements the SOP-MEC process.

In any of the administration embodiments herein, there can be a mortality tracking system to update mortality experience for each purchased COLI plan and for each group of plan policies administered by the system. That update experience can be aggregated for all COLI and BOLI or by plans using the system. In turn, actuarial consultants can be use the updated experience to modify the embedded mortality tables and thereby create proprietary mortality experience for the system.

As may be desired, an embodiment can be made to have the capability of reporting historical performance starting with the date of purchase (or the date of entering into a SOP or SPE) to the current reporting period and comparing actual results to original projections. An embodiment can also provide future projections using original mortality assumptions and as many new mortality assumptions as may be specified by the program user. These illustration capabilities are new management and reporting tools for institutional acquisitions of SOP rights or SPE interests. The reports and illustrations are produced by the means herein disclosed.

More particularly, there can be a computerized system and method to accumulate mortality data and to forecast mortality for selected groups of lives. The mortality data can be provided electronically to settlement investors as a part of the process to enable them to price one or more life insurance contracts without individual underwriting. The system should provide a high degree of accuracy with respect to projected mortality for a group of lives, e.g., enabling settlement investors to purchase COLI policies without individual underwriting of the respective insured lives. Further, the system can provide the COLI owner minimum sale price breakpoints specific to that companies financial situation and COLI holdings. The system can create a market for COLI that previously did not exist and a means to optimize the results to the COLI owner.

In addition, there can be a computerized system and method, as described in the previous paragraph, that can provide a high degree of accuracy with respect to projected mortality for a life or group of lives. Predictable mortality will enable settlement investors to enter into a SPE investment, a purchase, or a SOP transaction without individual underwriting of the respective insured lives. Further, the system can provide the COLI owner accurate projections of cash flows, book income (or loss) and rates of return from the transaction(s). Similarly, the system can provide settlement investor(s) with equivalently reliable forecasts of cash flow, earnings and rates of return from the same transaction(s). So doing, the system creates a new and previously unavailable route for the COLI owner to escape the GAAP Trap, preserve tax free gains at death of the insured, and assure neutral or positive book income until the anticipated death of the insured life.

The benefits of the SOP program for the settlement investor are even more pronounced. By contributing only a periodic premium to gain the right to be paid a portion of the death benefit of a COLI policy, the settlement investor is able to minimize or reduce its capital commitment, manage its cash flows, and enjoy a high level of confidence in the projected rate of return. Accordingly, the system can create a new market for a subdivisions a COLI policy—a market that previously did not exist. The system can also provide a means to informed choices by the COLI owner and settlement investor. This portion of the computerized system is discussed below under System Proposal Module.

Also more particularly, there can be an administrative computerized system and method to report the ongoing performance of:

plan sales to participants;

the assignment of a SOP interest to the settlement investor; or

a SPE entity to its creators and owners.

Administration can include periodic accounting and reporting of plan assets, fund transfers, accounting and reporting of death benefit proceeds, forecasting of future plan performance of an existing program, tracking mortality experience and updating mortality expectations and/or accounting and reporting of net amount at risk ratio. Also, administration can include computing and reporting of a change in rights pursuant to an endorsement (i.e. assignment) agreement. Changes in rights can include a termination of the agreement, options to purchase the policy subject to the endorsement, or a re-constitution of rights arising from the passage of time. Also, the system can provide for subdivision of a plan and reporting to the separate parties with owner interests in the plan policies. System capabilities can include computing the correct division of death proceeds and/or annual premiums where multiple parties have an interest therein. In addition, proper administration is useful so as to correctly credit split premium payments and administering the receipt and correct distribution of death proceeds. This portion of the computerized system is discussed below under System Administrative Module.

This system facilitates the aggregation of multiple COLI purchases, assignment of interests, or SPEs and accordingly eliminates plan administration from being a barrier to owning large numbers of policies for many settlement investors. Further the system design includes the capacity to receive program reports and forecasts from an external COLI policy administrative systems. The system can also provide means for vendor compensation to be paid in whole or in part when death benefit's are paid or alternatively, at plan inception. Additionally, the system can facilitate a broker-consultant's compensation to be paid on an annual basis via administrative fees or policy charges. Today, broker-consultant compensation is paid up front as a one time commission from the settlement investors purchase price. Reducing and deferring broker-consultant fees can improve the transaction performance for both the COLI owner and the settlement investor. Further, a broker-consultant with access to the system will be at a competitive advantage to broker-consultants without the system.

System Proposal Module—Mortality

This system can be designed to provide settlement investors with accurate mortality forecasts, enabling them to bid on COLI purchases and COLI owners to entertain bids, e.g., without the need to again underwrite their insured employees. To accomplish such goals, data is gathered from a variety of sources, preferably electronically transferred to the computer storage systems, processed, and returned to settlement investors and COLI owners to permit informed decision making.

The process can begin with the input of census and mortality data for a COLI plan. Also, an electronic copy of the life insurance contract with its terms can be entered into the system. The COLI owner also can submit company specific financial information to be used by the system. Such data can include cost of capital, marginal state and federal income tax rates, combined effective income tax rate, alternative minimum tax, net operating loss carryover, and any other relevant financial information. This information permits the system to compute the minimum price or other data to avoid the “GAAP Trap” on a policy sale or to achieve a targeted return on a sale. So doing, the COLI owner can identify the policies to offer for sale and the minimum price to avoid a charge to corporate earnings or to realize a particular gain.

In one embodiment, actuarial advisor(s) can provide historical mortality experience in electronic format for inclusion in the system data base. The mortality experience tables can be sorted by age/sex cells as well as by participant income levels or other population attribute. Mortality in COLI tends to be at a rate less than the average mortality of the population of all life insurance buyers. The COLI specific mortality tables can be used by the system to project mortality for a group of COLI insured lives.

Also, using the COLI plan census and actual mortality experience data received from the COLI owner, the system can create a specific mortality projection for the COLI group. While either the standardized COLI mortality tables or plan mortality projections may suffice for computing life expectancy for age/sex cells in a COLI census, a weighted average mortality projection prepared by the system may create a more accurate projection. Basically, plans with few insured lives and/or little mortality experience will tend to produce less reliable actual mortality experience. Mortality projections from such plans can heavily weight embedded mortality tables when preparing their forecasts.

System Proposal Module—Investor Criteria

System Proposal Module—Transaction Structures

System Proposal Module—Base Cases

System Proposal Module—Proposals

Settlement investors can electronically receive the census data of the COLI policies the COLI owner has offered for sale and the corresponding mortality projections. Census data includes each policy's cash value, face value, crediting rate(s), premium amount, policy loans, company retained death benefit accrued policy loan interest, and policy options. Settlement investor bids can be received by the system and processed into a bid format whereby the system computes projected cash flow and GAAP financial consequences of the bids. Where more than one bid is received, the system can prepare a comparative bid analysis for electronic or other transmittal to the COLI owner. This electronic worksheet permits the COLI owner to efficiently compare the bid(s) and even subdivide the bid(s) by age/sex cells among multiple bidders to maximize sale proceeds.

Once the COLI owner selects the settlement investor(s) offer, the system can prepare closing reports for both a settlement investor and a COLI owner. Also, a notice of the policy transfer can be prepared for the life insurance company.

The system's ability to generate accurate mortality forecasts can be important to the Split Ownership Module as it is for the Purchase Module above. Using forecasted mortality of an insured life and the financial attributes of the relevant life insurance contract, it is possible subdivide a policy into parts with different rights and obligations for a COLI owner and for a settlement investor. This process is not unlike a landowner who divides a parcel of real estate into two lots—one to be retained and a second lot to transfer to another party. In this instance, the COLI owner collaterally assigns part of the policy death proceeds to the settlement investor. In exchange, the settlement investor agrees to make periodic payments (i.e. premiums) to the carrier issuing the policy. While there are endless combinations of this structure, the anticipated prototype of the Split Ownership (“SO”) structure will be:

| Party | Obligation | Benefit |
|---|---|---|
| Settlement Investor | Cost of Insurance (“COI”) | FACE less Cash |
| | | Value at Death |
| COLI Owner | Premium less COIs, but | Cash Value at Death |
| | Not less than zero | |

Also, in the prototype transaction any policy loan debt interest obligations will remain with the COLI Owner.

In a SO transaction, the settlement investor is not required to make a significant capital investment to buy the policy. Instead, the investor makes periodic (e.g., annual) payments equal to some part the COI charges within a policy to compensate an underwriter for the risk of death of the insured. Typically the settlement investor's assigned portion of the death benefit is expected to be the “net amount at risk” portion of the policy gross face. In essence, the settlement investor carves out of the policy those attributes which look very much like a term life contract.

Under a SOP, the COLI owner continues to be the policy owner. The owner's partial assignment of part of the death proceeds is via a collateral assignment; a conveyance similar to a lien but which is not a sale. The COLI owner continues to hold the legal title to the policy even though certain rights have been assigned. The policy owner retains rights and title to the policy cash value, the owner records cash value changes as income (or loss), and the owner receives the cash value at the death of the insured as tax free proceeds.

The system can model the Split Ownership structure and reflect the financial consequences of a SOP both to the settlement investor and to the COLI owner. More particularly, the system can prepare forecasts and historical reports of transaction effects on:

Cash flows;

GAAP Income (or loss);

Book financials; and/or

Income tax (or loss).

For a settlement investor, the system can project the expected internal rate of return from its participation in a SOP. Included among the system variables to compute the above projections and reports are—system generated mortality rates, user designated policy crediting or growth rates, policy COIs, policy loads, policy loans, and the contract face amount (and/or benefit formula).

With policy data recorded in the system, an embodiment can compute the tax basis for that policy. Normally prior to entering into a SOP, a COLI owner will want to withdraw policy cash value equal to or less than tax basis of the life insurance contract. Any distribution from a policy in excess of tax basis will be taxed as ordinary income to the owner. Distributions less than or equal to tax basis are unrestricted after-tax cash. Where policy loans are in place, a distribution can be used either to reduce or retire the policy loan debt. The system can reflect policy withdrawals and debt repayments when creating the forecasts and historical reports noted above. In addition, the system can provide projections and reports that include any policy loans that remain after the policy partial withdrawal of cash value.

System Administrative Module

After the sale or a SOP transaction, administration of the policies can be important to institutional investors. The administration can be performed by a computer system such as the one embodied herein.

Administration can include scheduling premium due dates and other payments, if any, on COLI policies. Periodically (e.g., annually, quarterly) reporting death benefits, tax and book basis of the COLI plans, comparison of past projections to actual policy performances, projection of future plan performance and historical performance reporting. The system can also maintain a record of separate owner interests in death proceeds as well as parties' obligations to pay portions of premiums. In order to obtain employee consents, many companies promised to pay insured participants a modest company paid death benefit. Because the company death benefit promise is separate from the COLI policy, a COLI owner can retain an interest in a sold policy equal to (or a fraction of) the company paid death benefit and have the investor remit that amount to the seller upon death of the insured employee. So doing, the employer's death benefit payout is offset by its collection of a portion of the death proceeds. Where this situation is encountered, it can be important to maintain a record of the retained death benefit interest and assure that the carrier makes that separate death benefit payment to the COLI owner (i.e., the seller).

Another system administrative feature can be used to enable tracking and reporting of a unique new contract designed to pay a predetermined amount to a settlement investor should an insured life survive beyond his actuarial projected date of death. Such contracts can be referred to as a “Survival Date Policy” or “SDP” insurance. Where applicable, this embodiment tracks the SDP date for each person and creates periodic reports of policies (with their policy attributes) with SDP dates that are pending and SDP dates that have past. Similarly, the system can track death proceeds, if any, assigned to the SDP underwriter and create policy administrative reports for the SDP underwriter with respect to its assigned policies.

Also as may be desired, the administration system can track actual mortality experience for each plan and make one or more comparisons to prior mortality projections. These actual vs. projected mortality reports can be submitted electronically to a consulting actuary to be used to determine if the embedded mortality tables should be updated. In so doing, over time, the mortality tables within the system will become very accurate. Settlement investors will become more and more confident that in the aggregate their policy holding periods (or SO agreement periods) will be as first forecasted by the system.

Accordingly, one of many ways of considering this teaching is as a system and process linking an external computer with a system of one or more parties of interest such as a COLI or BOLI owner, a Settlement Investor, a System Administrator, a Broker-Consultant, a Life Insurance Carrier or other Underwriter(s), an Actuarial Consultant, an External COLI/BOLI Reporting System,a SPE, or a Death Tracking Service in providing processes, projections and information to enable the purchase and the sale of one or more COLI policies, an assignment or endorsement of a part of one or more policies via a SOP, or the transfer of one or more MEC policies to a SPE via a transfer previously described as a SPE. There can be a system and process linking an external computer with a system of one or more parties of interest such as a COLI or BOLI owner, a Settlement Investor, a System Administrator, a Broker-Consultant, a Life Insurance Carrier or other Underwriter, an Actuarial Consultant, an External COLI/ BOLI Reporting System, a SPE,or a Death Tracking Service to provide processes and information to provide efficient and effective administration of large numbers of COLI policies and/or plans purchased or subject to a SOP or SPE. There can be a system creating historical and projected mortality for each COLI or BOLI program submitted, updating mortality data for policies included in a plan, and/or aggregating mortality experience and forecasts, e.g., by user defined criteria.

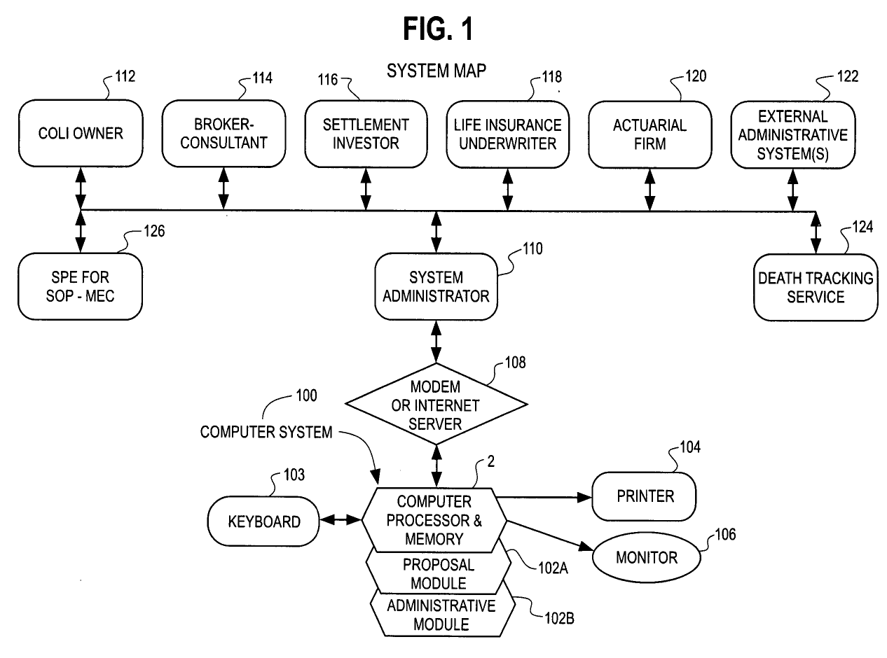

Referring now to the drawings, and initially FIG. 1, there is set forth a system architecture diagram according to a representative embodiment. A computer system 100 is coupled by a computer-to-computer communication device, such as, for example, an internet server 108 to a system administrator's computer system 110. In the diagram, the administrator's system also serves as the conduit for data transfers to and from other parties of interest, including, an owner of a COLI plan 112, a broker-consultant's computer 114, a settlement investor's computer 116, a life insurance underwriter's computer 118, an actuarial firm computer 120, an external policy reporting and administration system computer 122, the computer of a death tracking service vendor 124 and the SPE's computer 126. The system administrator's connection to these other computers will most likely be via an internet server, or an intranet server or modem might also be possible in certain circumstances.

Separate and equally viable embodiments would link computers 112,114,116,118, 120, 122,124 and 126 directly to computer 100 in addition to or instead of using computer 110 as a conduit.

According to an embodiment, the computer system 100 is operated by the system administrator for the benefit of parties to the SOP transaction—the COLI owner and the settlement investor. Accordingly, the computer system 100 is external to the computer systems at 110, 112, 114, 116, 118, 120, 122, 124 and 126. The computer system 100 is programmed to receive, process, and store plan event data. This data is then used to prepare historical performance computations and various measures of financial performance. The computer system 100 also uses event data to certain financial relationships which, by prior agreement, give rise to rights or the loss of rights of either the COLI owner 112 or the settlement investor 116.

Also, the computer system 100 facilitates the matching of the separate interests of the COLI owner 112 and the settlement investor 114 by illustrating the financial consequences of a policy endorsement—cash flow and book earnings to the SOP and SPE plan participants.

Under SOP or SPE there is no individual underwriting of the insured lives in a COLI plan prior to the transaction date. Accordingly, a determination of future mortality and/or life expectancy is very important. The computer system 100 is designed to accumulate mortality experience (including experience of plans prior to the SOP endorsement event). The computer system 100 is designed to create a plan specific mortality tables and a mortality table using the mortality experience of all plans administered through the computer system 100. Also, the computer system 100 accepts pre-existing mortality tables from an actuarial firm for future use and/or conversion to life expectancy tables. Examples of such tables include the Milliman USA 2001 Ultimate Tables and the 1994 Group Annuity Mortality Table. With multiple mortality tables at the disposal of the system administrator, it is possible to prepare as many illustrations as needed to permit the COLI owner 112 and the settlement investor 116 (and the broker-consultant 114) to gain an understanding of the probable outcome of a SOP endorsement transaction. Further, once a SOP or SPE program is in place, the same mortality tables will permit a dependable measurement of progress and a periodic updating of forecasts of future performance with an ever increasing degree of accuracy.

Typically, the computer system 100 comprise of a processor, such as an Intel PENTIUM™, memory 2 (e.g. a RAM memory and secondary memory devices such as a UBS jump drive, a CD-ROM drive, etc.) an input device (such as a keyboard 103 with a mouse and/or trackball) an output device (such as a printer 104 or a computer monitor 106) and an internet server device 108 to transmit and to receive data and other communications via the internet (a modem is an alternative transmission device). The computer system 100 also includes an operating system such as, for example, the Microsoft Windows XP operating system. Also, the computer system 100 includes 2 modules: a Proposal Module 102A and an Administrative Module 102B. The first module is programmed to produce illustrations to be used for decision making prior to executing an SOP or SPE agreement. Also, the Proposal Module 102A creates a base case illustration at the time a SOP or SPE is formed. A base case illustration is a management tool for the future to compare against actual results. The Administrative Module 102B is designed for both periodic plan reporting, including financial reporting and death tracking, and periodic forecasting using the current plan status as the platform for a future performance forecast.

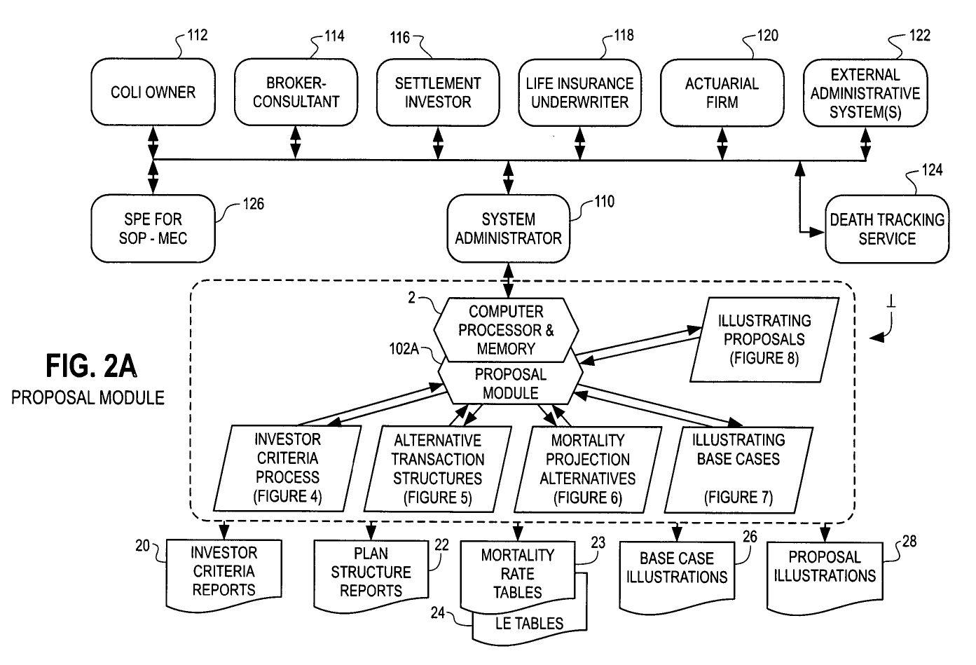

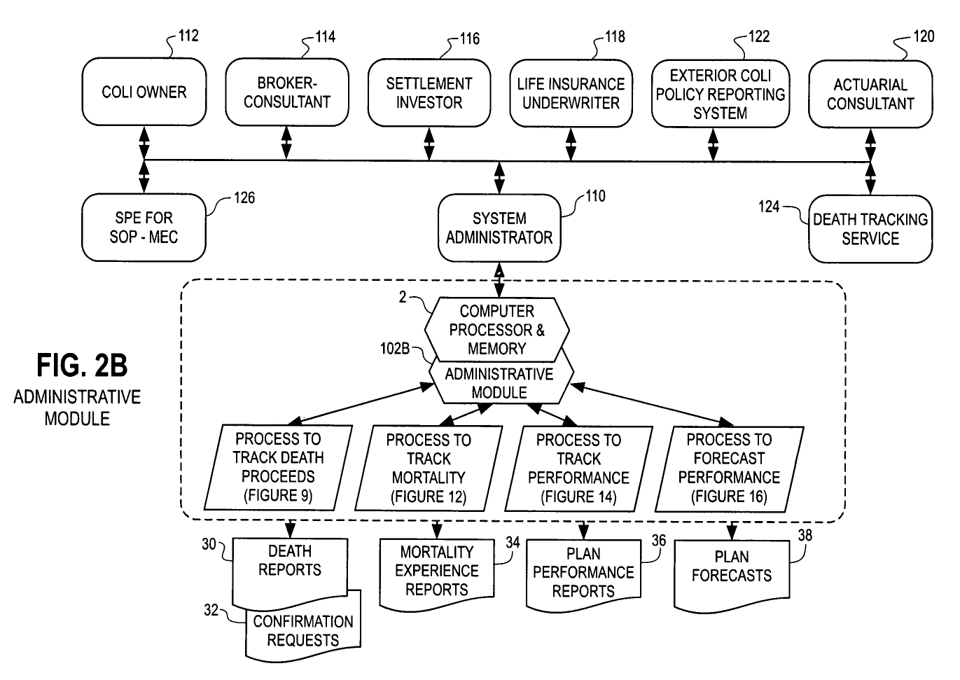

FIG. 2A and 2B are block diagrams showing the software components 1 as they structure the functionality of the present embodiment. Certain software components control the operation of and provide the functionality to computer system 100. The current embodiment of the present embodiment at FIG. 2A includes five separate process systems which can run simultaneously or separately: Investor Criteria Process 4, Alternative Transaction Structures Process 5, Mortality Projection Alternatives Process 6, Illustrating Base Cases Process 7, and Illustrating Proposals Process 8. Also, the current embodiment of the present embodiment at FIG. 2B includes five separate process systems which can run simultaneously or separately: Process to Track Death Proceeds 9, Process to Track Mortality 12, Process to Report Performance 14, and Process to Forecast Performance 16.

In general, information transfers to and from computer system 100 and system administrator 110 (or alternatively between computer system 100 and systems 110, 112, 114, 116, 118, 120, 122, 124, and 126). In the current embodiment, the system administrator 110 is the transferor and recipient of all information to and from computer system 100. (Alternatively, all external systems could be in direct communication with computer system 100.) Accordingly, Plan Administrator 110 collects and transmits to computer system 100, information such as carrier policy data, insured life data, previously insured deceased life data, COLI owner data, settlement investor data, plan structure data, death tracking report data, prior COLI plan death experience data, third party actuarial mortality table data, other investment data for a SPE, and data in the form of illustrations, reports or forecasts prepared by an external administrative system. Upon receiving information, computer system 100 stores the information in memory 2 according to the data structures of the present embodiment. This allows the computer system 100 to read information from memory 2 for use in the various system processes.

Each of the nine system processes—Investor Criteria Process 4, Alternative Transaction Structures Process 5, Mortality Projection Alternatives Process 6, Illustrating Base Cases Process 7, Illustrating Proposals Process 8, Process to Track Death Proceeds 9, Process to Track Mortality 12, Process to Report Performance 14, and Process to Forecast Performance 16—generates reports reflecting its computations, data sorts, and data processing. To facilitate distribution of reports, the system administrator 110 codes report distributions as to which system should receive which report. Also, the coding can designate a report to be automatically remitted to one more system or only be remitted by command of the system administrator. Accordingly, The Plan Administrator 110 electronically receives and stores each illustration, updated mortality table, report and forecast and its system electronically re-sends its electronic file receipts to an owner of a COLI plan 112, a broker-consultant's computer 114, a settlement investor's computer 116, a life insurance underwriter's computer 118, an actuarial firm computer 120, an external policy reporting and administration system computer 122, the computer of a death tracking service vendor 124 and the SPE's computer 126. Files are forward automatically or per instruction of the system administrator, per the coding entered at system administrator 110.

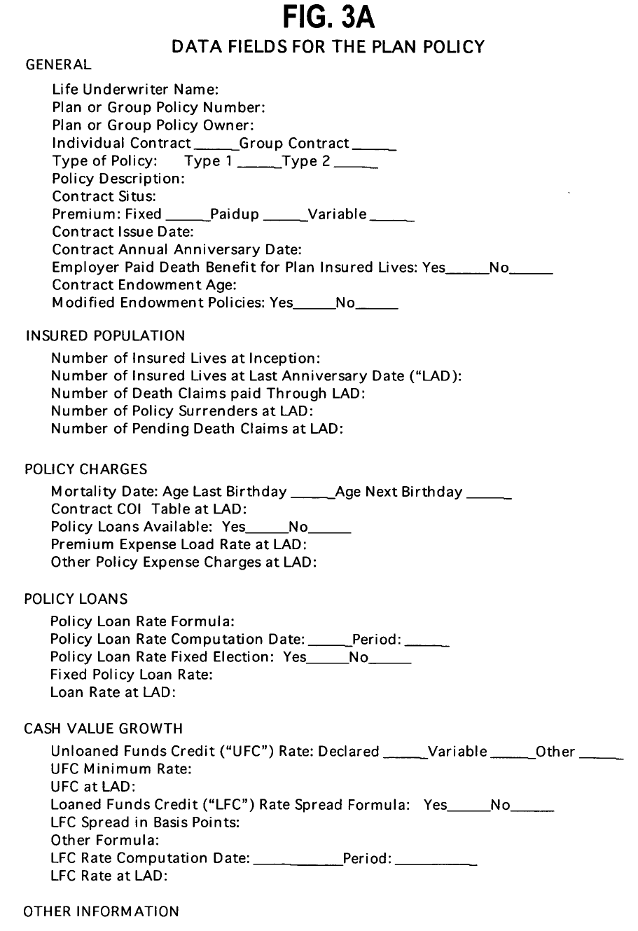

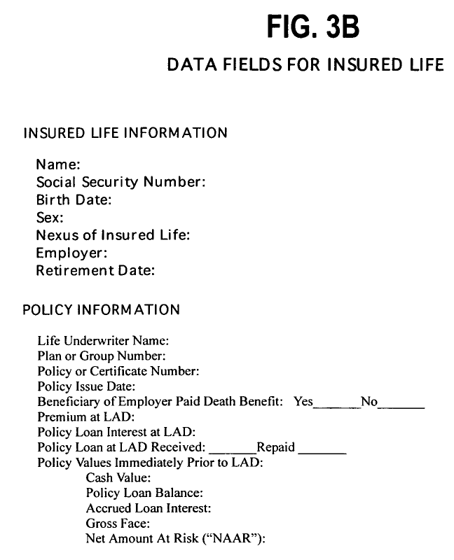

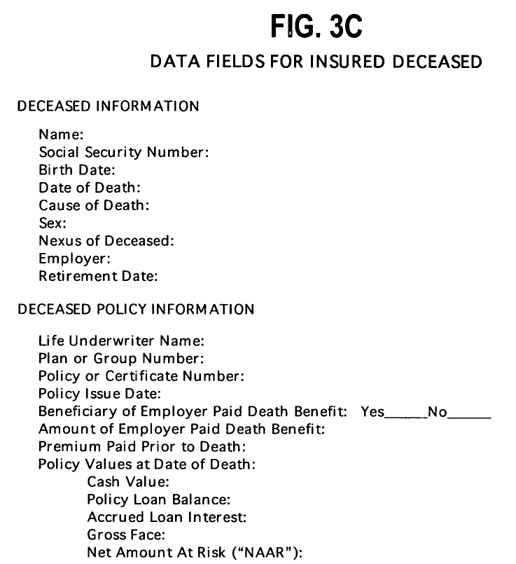

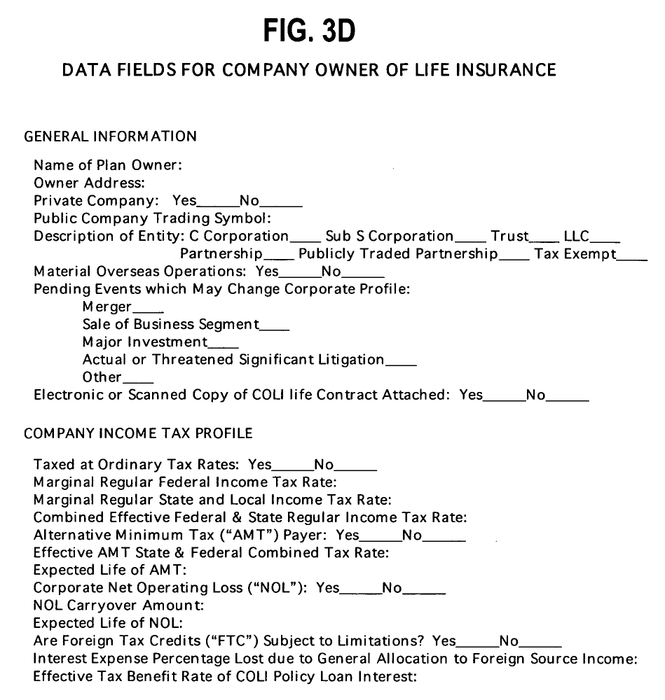

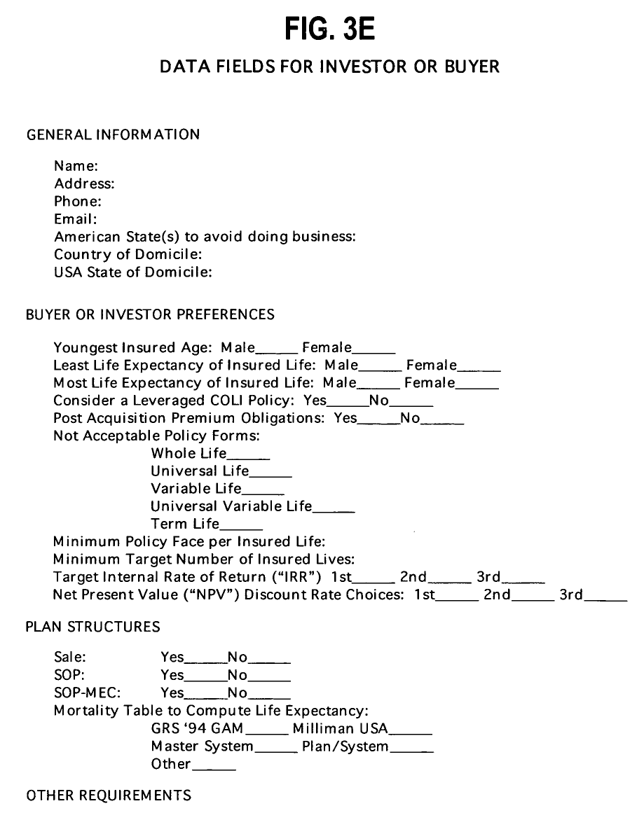

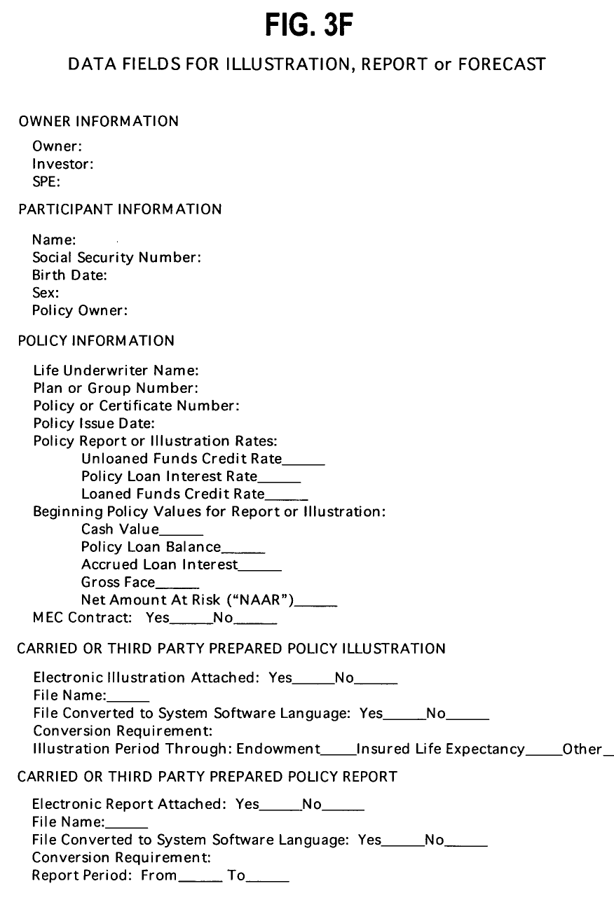

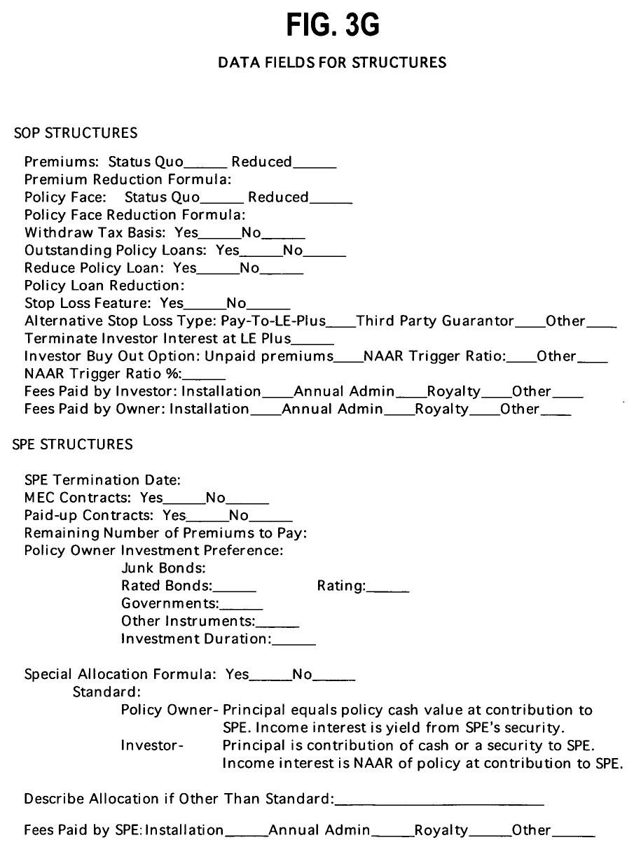

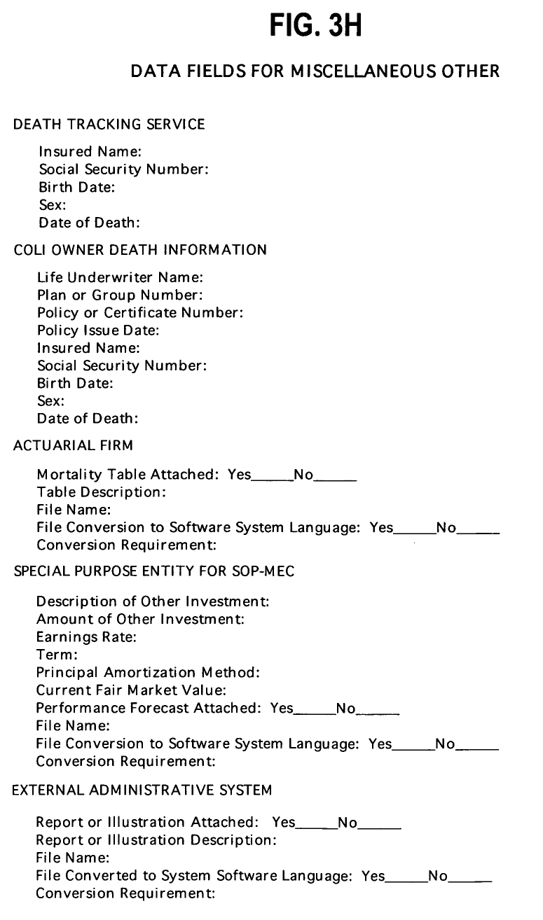

FIG. 3A sets forth in columnar form carrier policy data received by system administrator 110 from one more of the following: the COLI Owner System 112, the Broker-Consultant System 114, the Life Insurance Underwriter System 118, and/or External Administrative System 122. System administrator 110 electronically conveys the data to Computer System 100 Memory 2.

FIG. 3B reflects in columnar form the insured life data received by system administrator 110 from one more of the following: the COLI Owner System 112, the Broker-Consultant System 114, the Life Insurance Underwriter System 118, and/or External Administrative System 122. System administrator 110 electronically conveys the data to Computer System 100 Memory 2.

FIG. 3C reflects in columnar form the deceased life data for a COLI, prior to an SOP or SPE, that is received by system administrator 110 from one more of the following: the COLI Owner System 112, the Broker-Consultant System 114, the Life Insurance Underwriter System 118, and/or External Administrative System 122. System administrator 110 electronically conveys the data to Computer System 100, Memory 2.

FIG. 3D reflects in columnar form the COLI owner data potentially relevant to a SOP or SPE transaction. This information is received from the COLI Owner System 112. System administrator 110 electronically conveys the data to Computer System 100, Memory 2.

FIG. 3E reflects in columnar form the settlement investor data, including investor preferences such as sex of insured, age of insured, type of structure (Sale, SOP or SPE), policy form, and mortality table. This information is received from the Settlement Investor System 116. System administrator 110 electronically conveys the data to Computer System 100, Memory 2.

FIG. 3F reflects in columnar form the policy external data received in the form of period report of insured life policy values, a forecast of future cash flows and/or earnings or a policy illustration. The data also includes the identity of the insured lives, the policy owner, the carrier, the policy, policy elections, and policy MEC status. This information is received by system administrator 110 from one more of the following: the COLI Owner System 112, the Broker-Consultant System 114, the Life Insurance Underwriter System 118, and/or External Administrative System 122. System administrator 110 electronically conveys the data to Computer System 100 Memory 2.

FIG. 3G reflects in columnar form data of the separate structures for a SOP and a SPE. Among the list of data items is the rate of return targets for an investor, duration of the programs or insured life inclusion in a plan, fees arising from the transaction, among other important items. This information is received by system administrator 110 from one more of the following: the System Administrator 110, the COLI Owner System 112, the Broker-Consultant System 114, the Life Insurance Underwriter System 118, SPE System 126 and/or External Administrative System 122. System administrator 110 electronically conveys the data to Computer System 100 Memory 2.

FIG. 3H reflects in columnar forms data from Death Tracking Services 124, death data received from the COLI Owner 112, mortality table data received from Actuarial Firm 120, SPE other investment data received from SPE 126, policy forecast or reports received from an External Administrative System 122. System administrator 110 electronically conveys the data to Computer System 100, Memory 2.

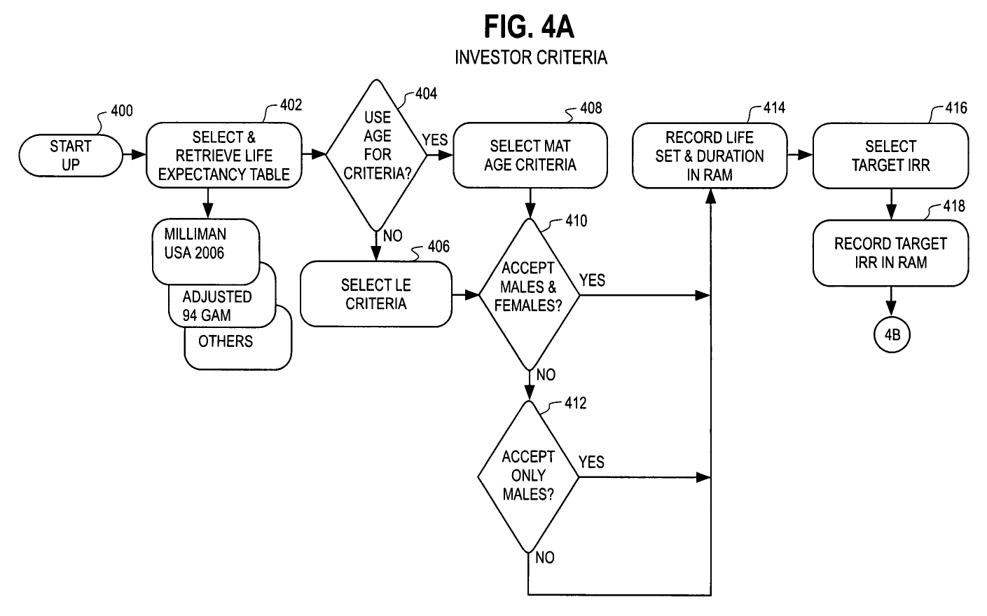

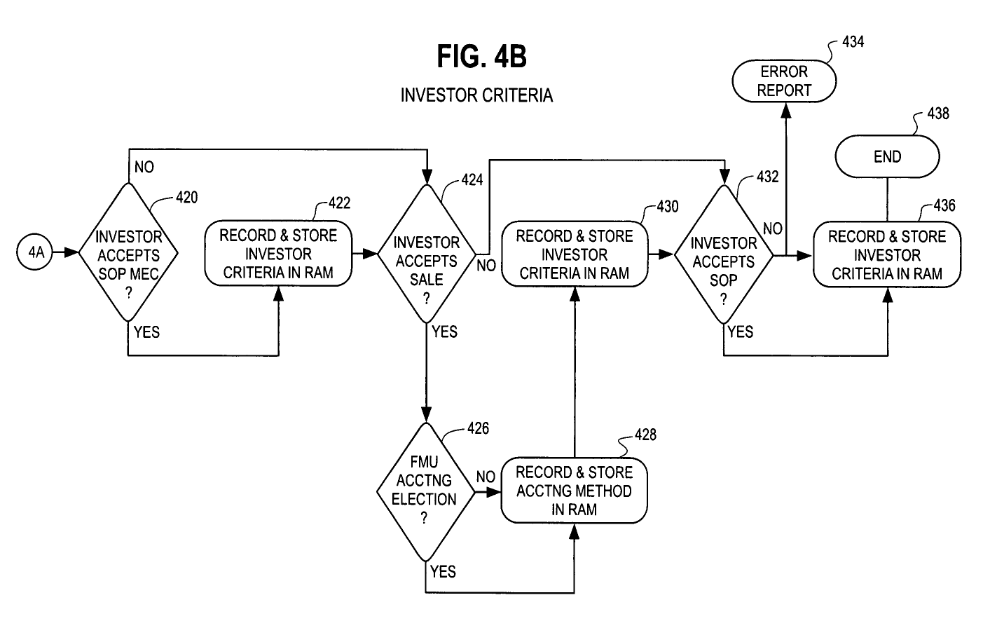

FIG. 4 (collectively FIGS. 4A-4B) is a block diagram of the Investor Criteria Process 4 portion of the computer system 100. The steps in the process determine a data set of investor criteria for entering into a SOP or SPE transaction. These steps record the investor's willingness to enter into a purchase, a SOP, and/or SPE. Other data includes choice of mortality table for an illustration, target internal rate of return (“IRR”) accounting election under FASB Technical Bulletin 85-4-1 and in selecting settlement lives, life expectancy, age and/or sex criteria.

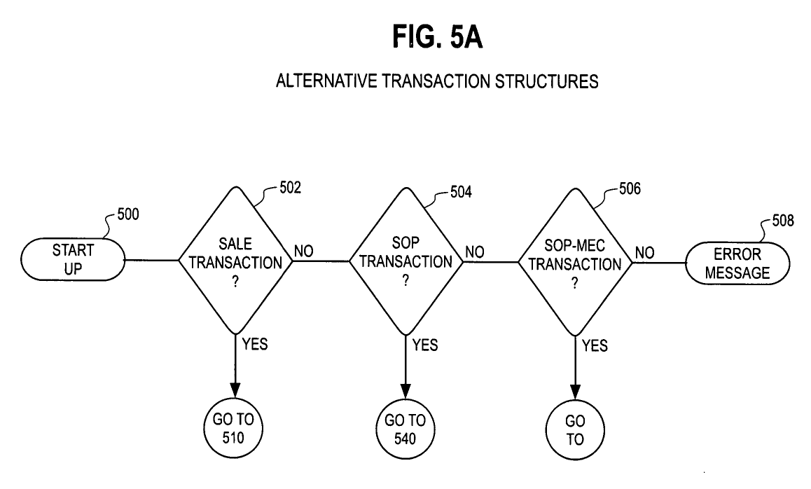

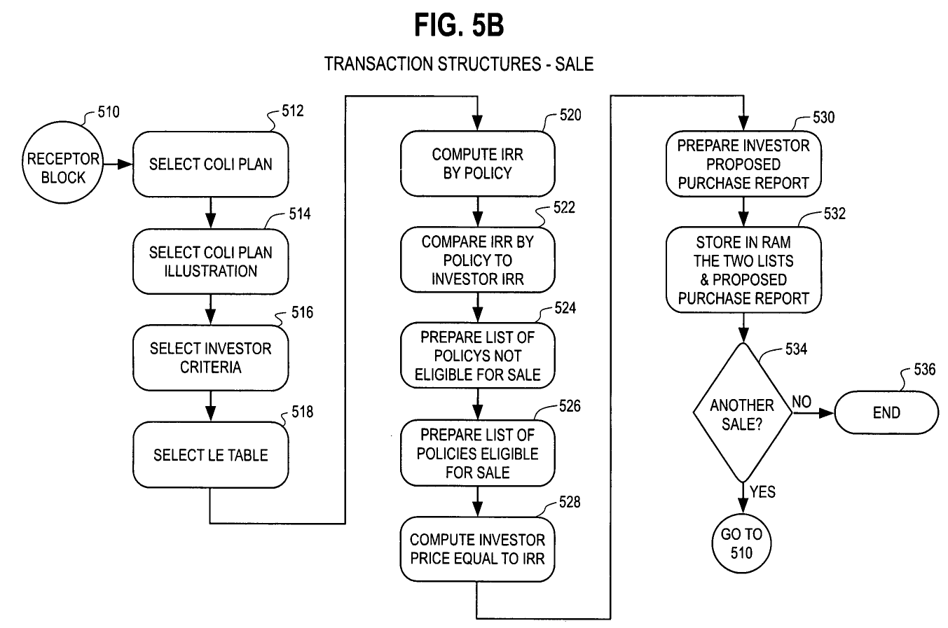

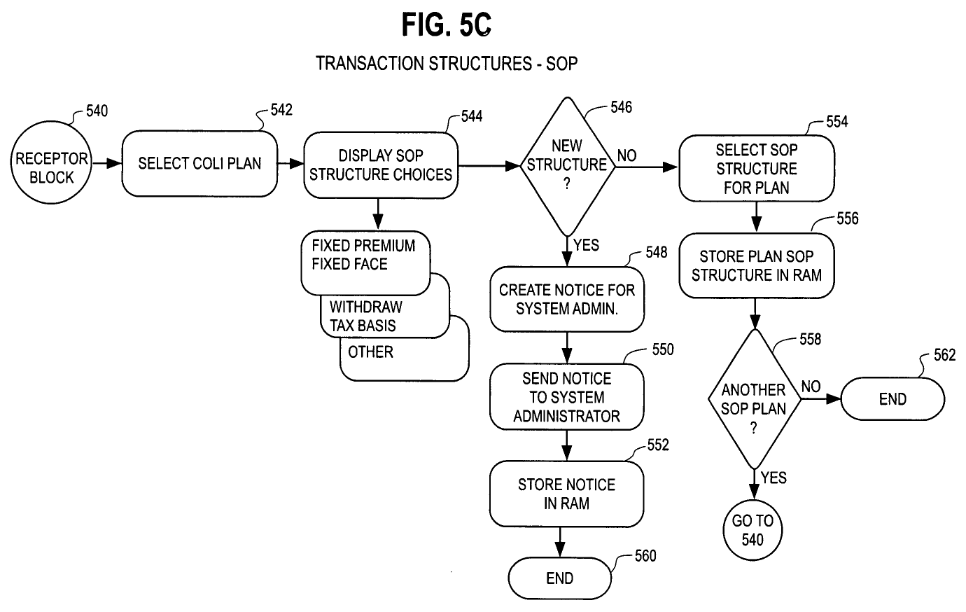

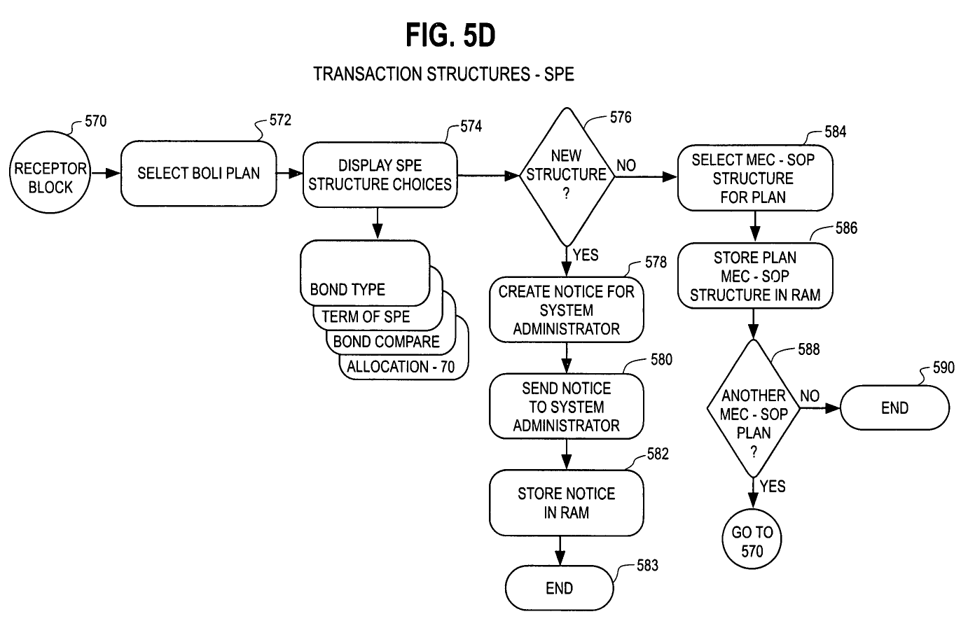

FIG. 5 (collectively FIGS. 5A-5D) is a block diagram of the Alternative Transaction Structures Process 5 portion of the computer system 100. The steps in the system are designed to determine the plan structure selection for an investor user. First, the system steps identify which type of plan is to be considered—a sale, a SOP or a SPE. For a sale, the system determines which policies meet the target return requirements of the investor and the maximum price to be paid using that constraint. For a SOP, the system calls up the systems embedded plan structure choices and determines if new structure alternates are to be added to the Computer System 100 Memory 2. If changes are required, a notice is automatically prepared and sent to the system administrator. From the system choices of structures, the investor selects the structure to be used in the next illustration. The same steps are performed for a SPE structure.

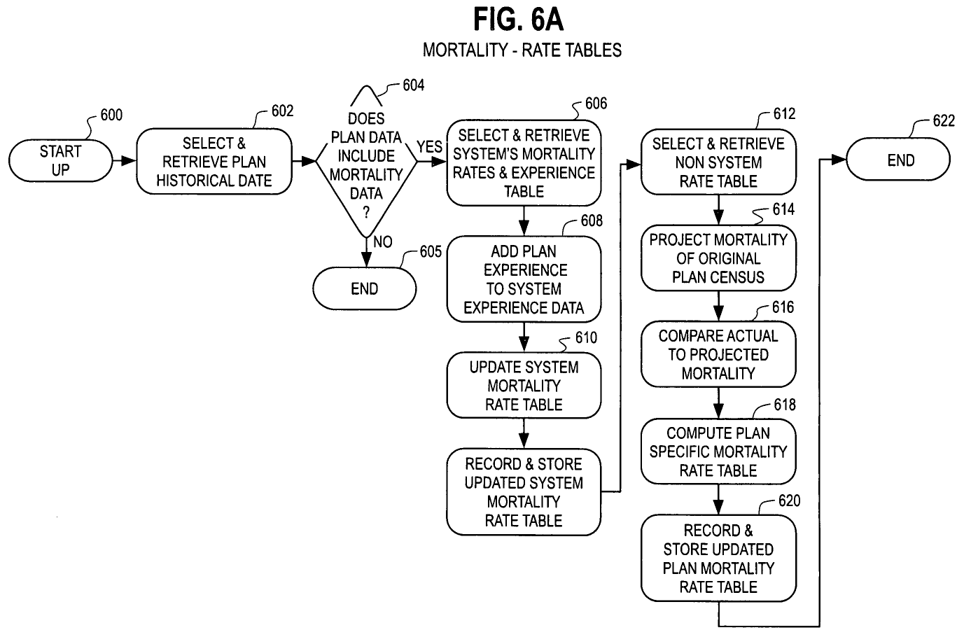

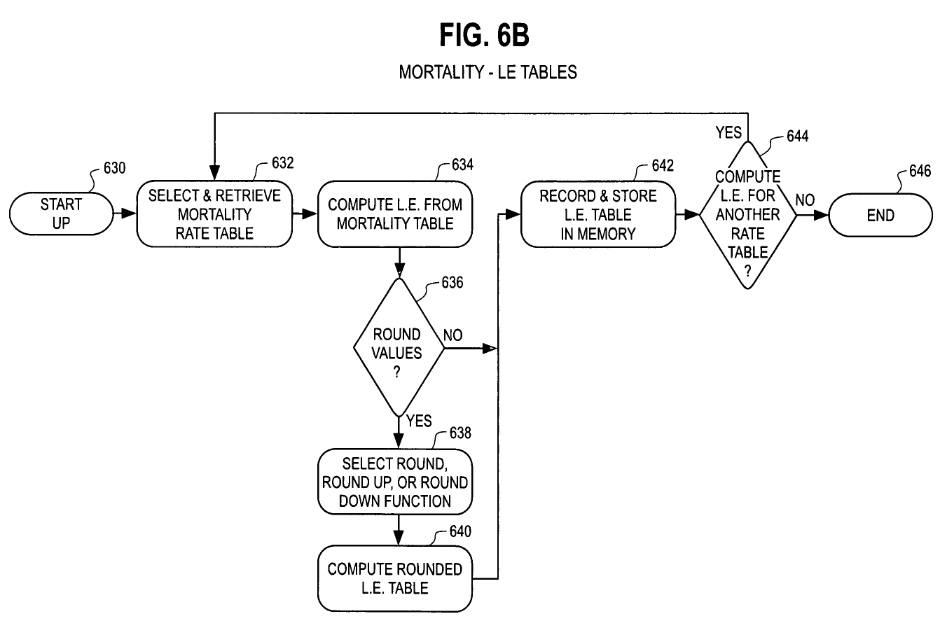

FIG. 6 (collectively FIGS. 6A-6B) is a block diagram of the Mortality Projection Alternatives Process 6 portion of the computer system 100. These steps of the system compute the mortality table based on all mortality data collected from plans as their data is entered into the system. Also, there are steps to compute plan specific mortality tables using plan experience data. Also, there are steps to convert a mortality table to a table of life expectancy to be used in other system computations.

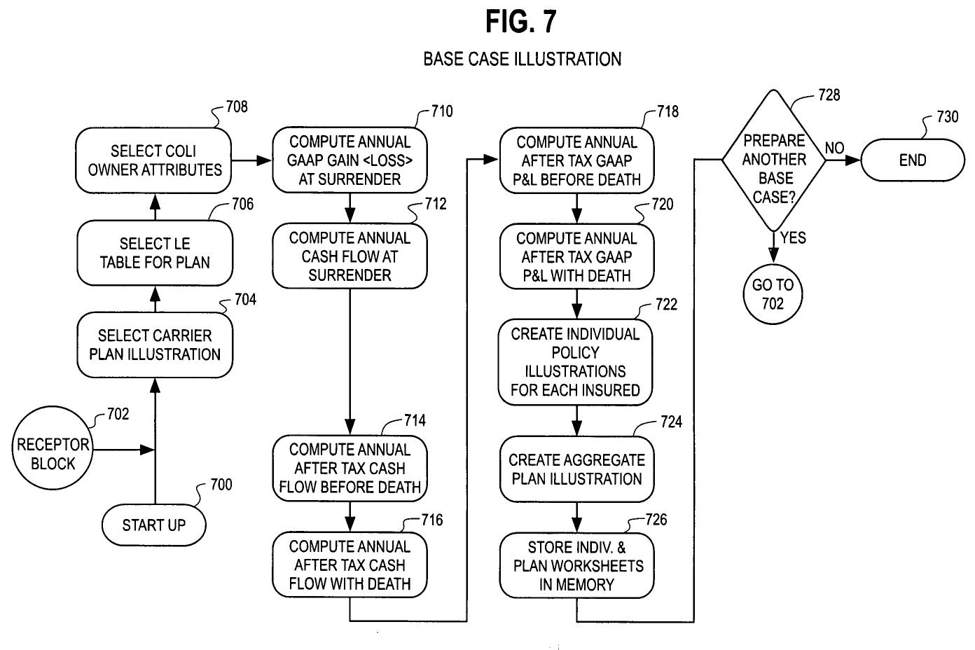

FIG. 7 is a block diagram of the Base Case Illustration Process 7 portion of the computer system 100. These steps of the system compute an illustration at the inception of a SOP program. The illustration includes the financial performance for both the policy owner and the settlement investor participating in the endorsement transaction.

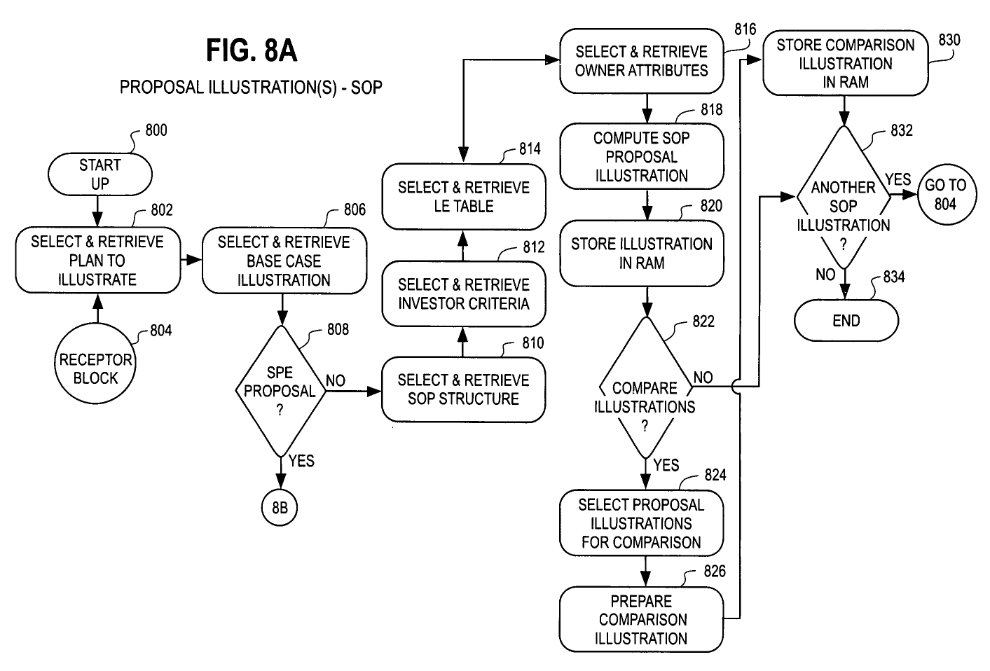

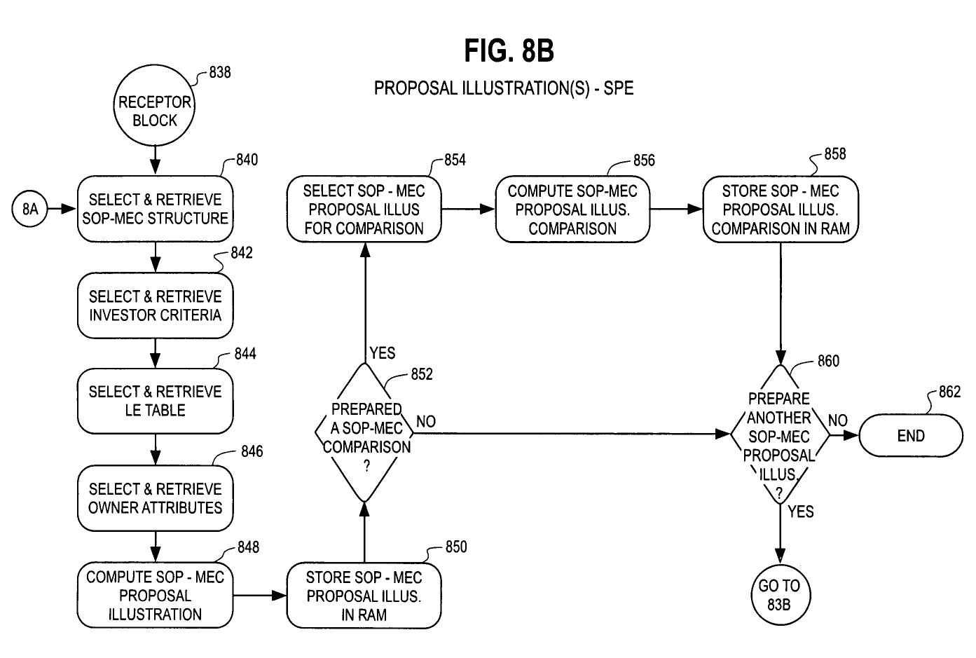

FIG. 8 (collectively FIGS. 8A-8B) is a block diagram of the Proposal Illustration Process 8 portion of the computer system 100. These steps of the system compute an illustration for either a SOP or a SPE program. Also, the system steps permit the user to compute multiple illustrations and compare one to the other. The illustration includes the financial performance for both the policy owner and the settlement investor participating in the SOP or SPE transactions.

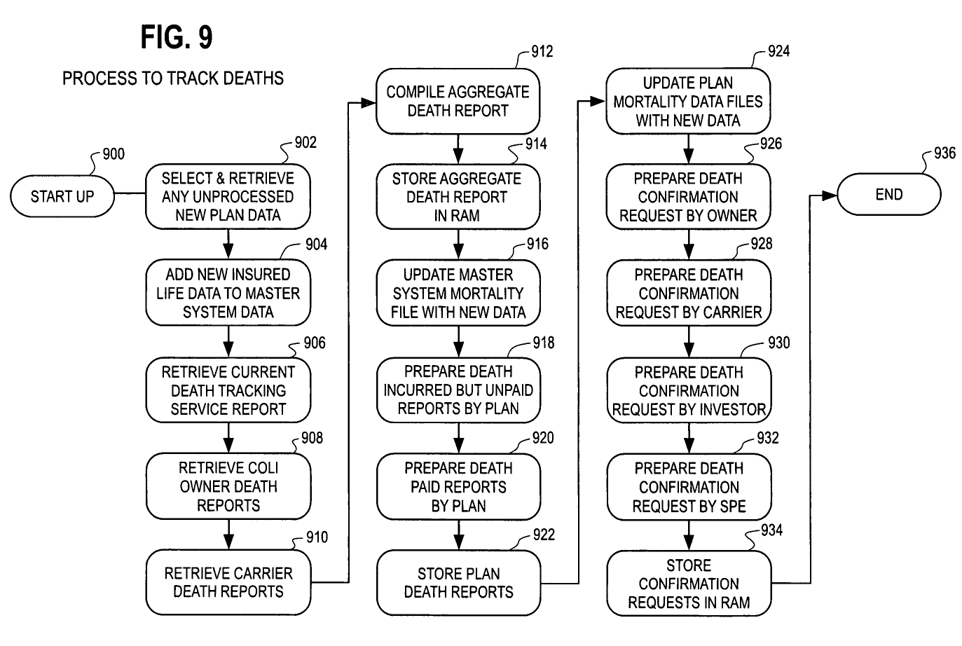

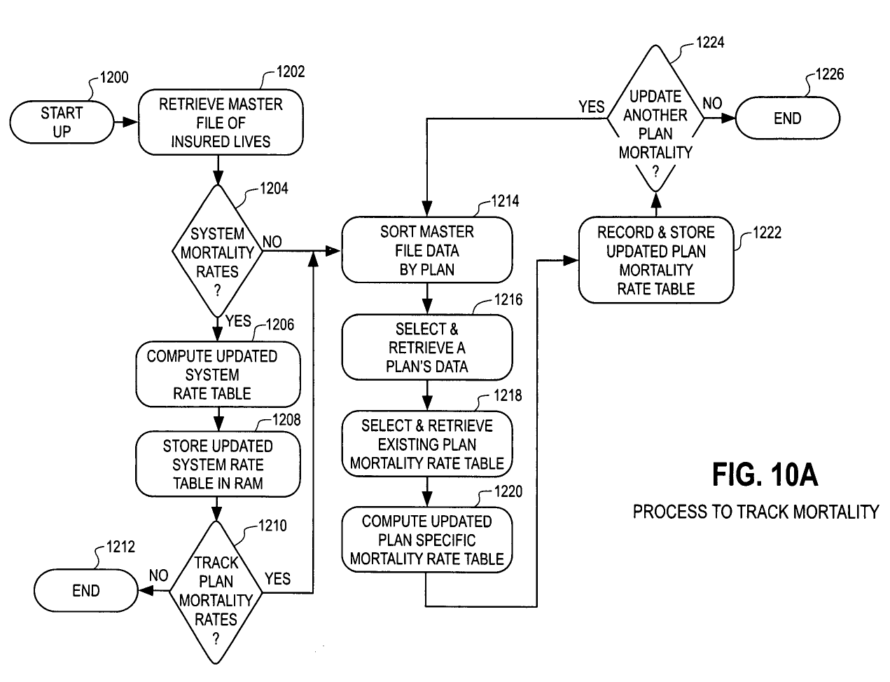

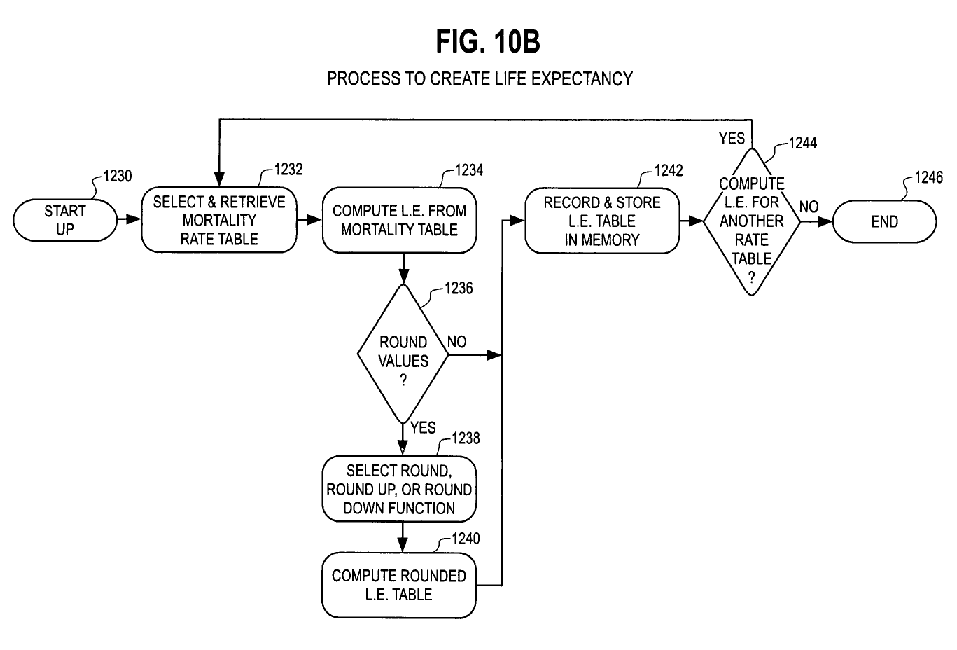

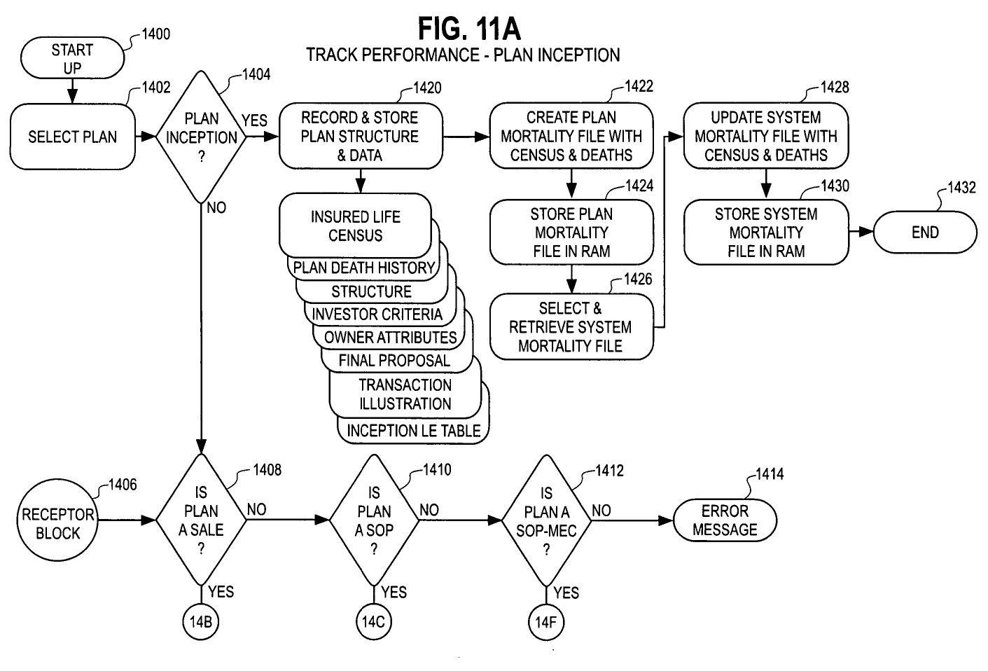

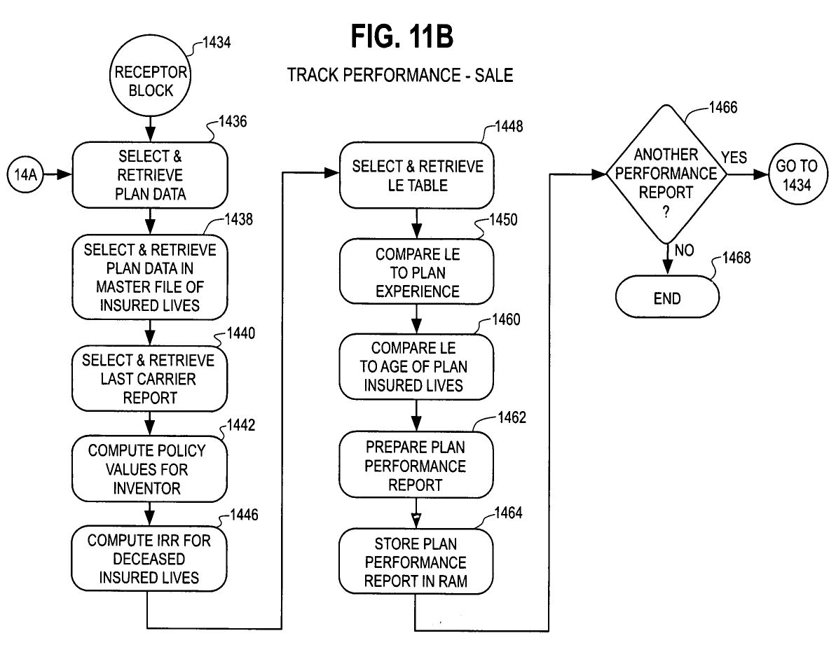

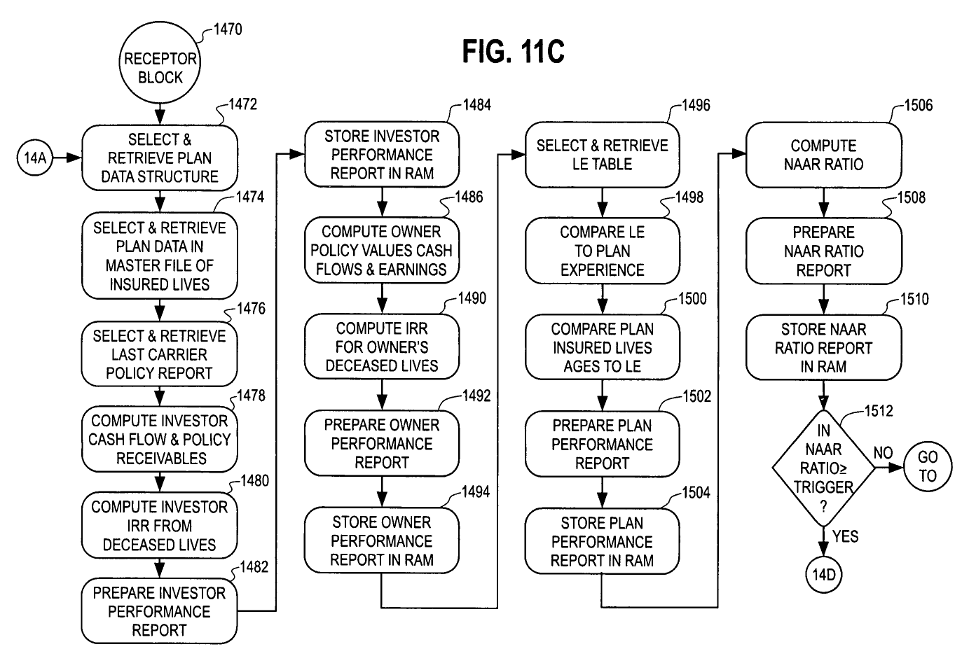

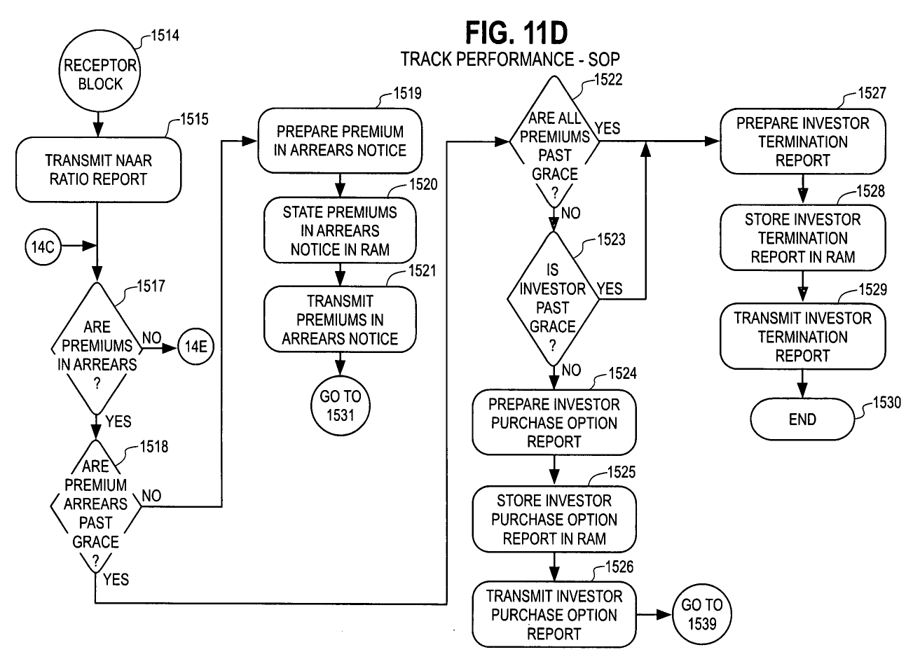

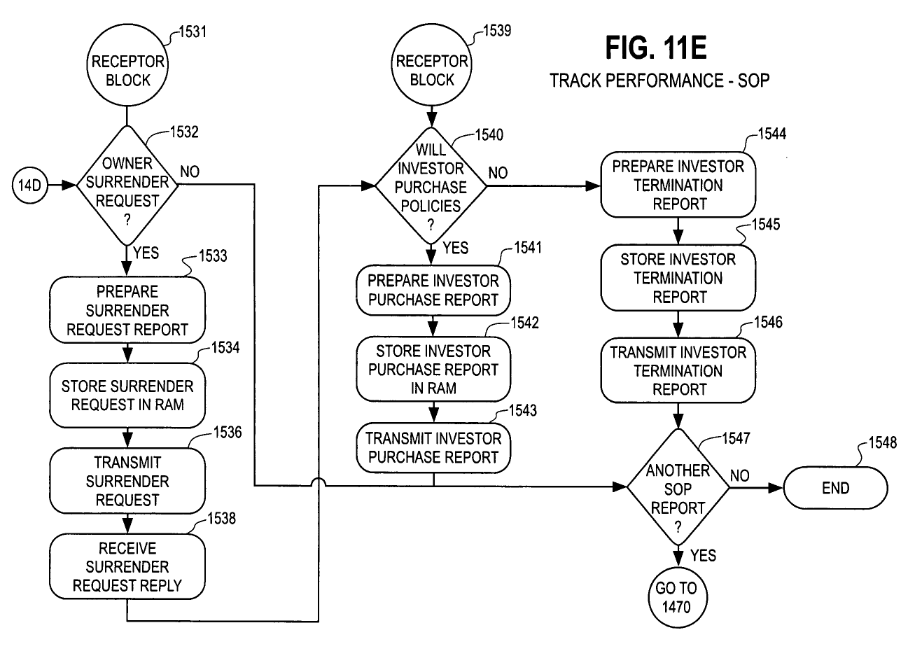

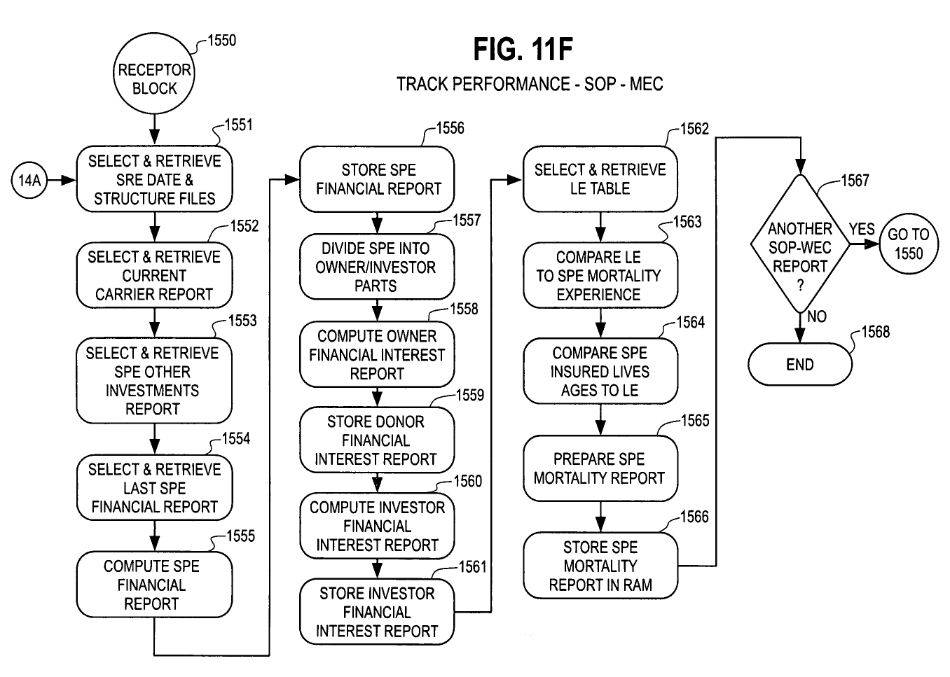

FIG. 9 is a block diagram of the Process to Track Deaths 9 portion of the computer system 100. These steps of the system aggregate death reports from Death Tracking Service 124, the COLI Owner 112, and the Life Insurance Underwriter 118 to identify deaths of all plans recorded in the system. Reports of deaths incurred but not yet paid and deaths claims paid are prepared for distribution by the System Administrator 110. Similarly the system steps prepare confirmation death reports for distribution to COLI Owners 112, Life Insurance Underwriters 118, Settlement Investors 116 and SPEs 126. Electronic distribution of this information enables accurate and efficient control of the process of collecting death process for the benefit of the plans.

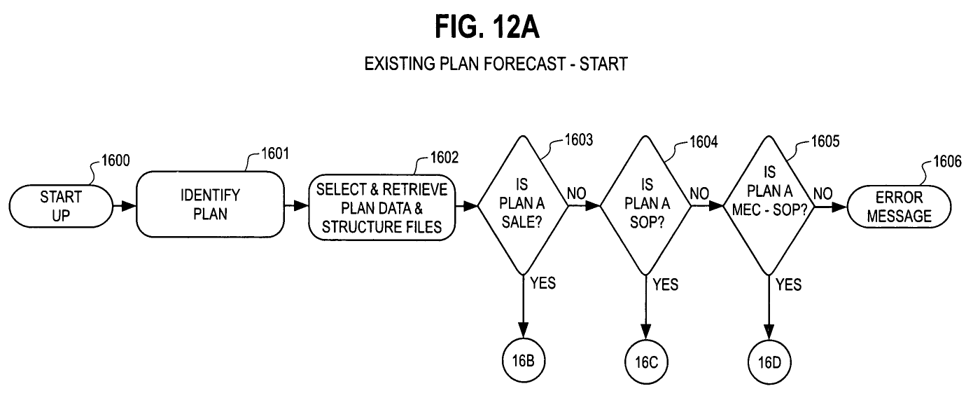

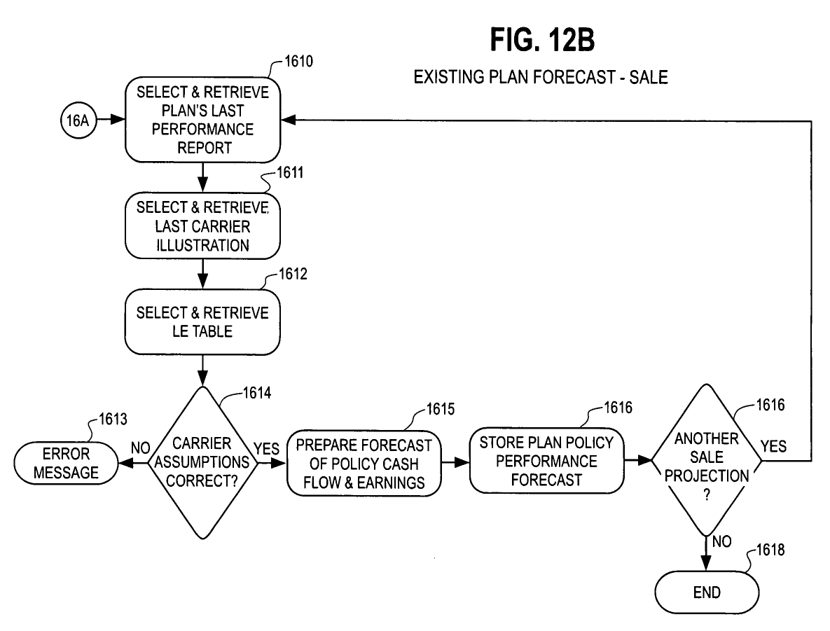

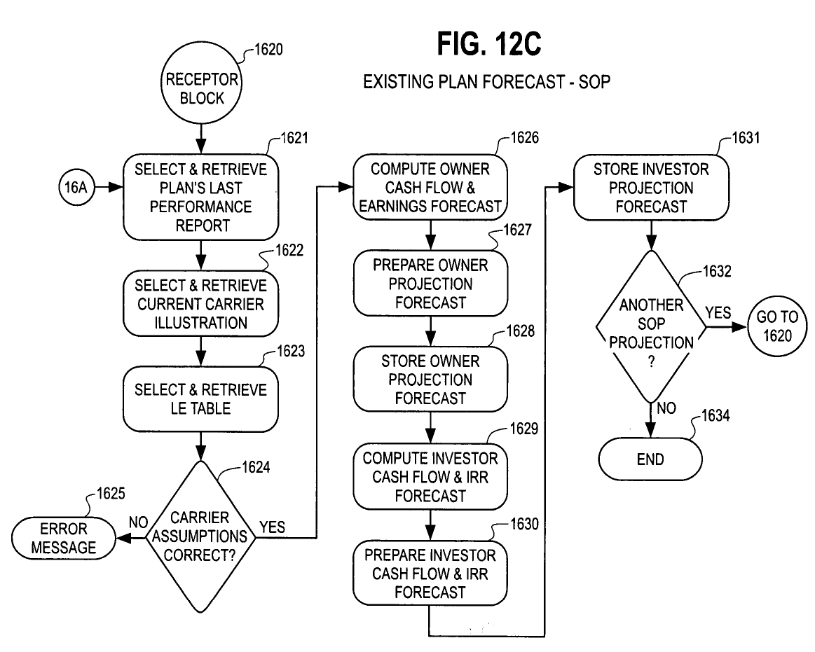

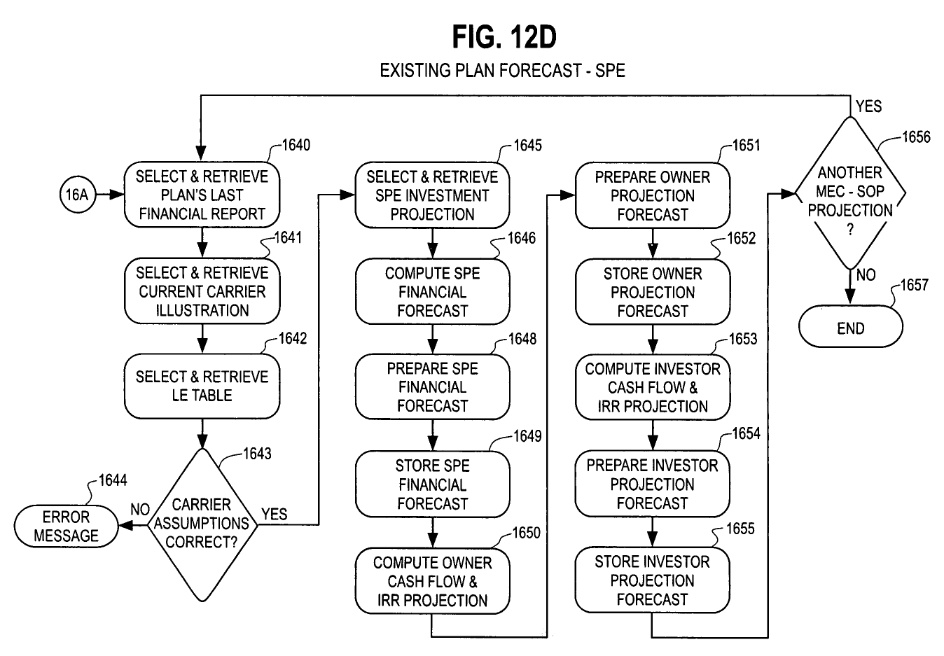

FIG. 12 (collectively FIGS. 12A-12B) is a block diagram of the Process to Track Mortality portion of the computer system 100. These steps of the system are similar to FIG. 6. These steps, however, add plan mortality experience to the system after plan inception. The additions apply both to the system aggregate mortality table and separate plan tables. As time passes, then, these mortality tables become more and more accurate for use in reports and forecasts.

FIG. 14 (collectively FIGS. 14A-14F) is a block diagram of the Process to Report Performance 14 portion of the computer system 100. This portion of the system computes periodic performance reports for all plan types; purchase, SOP or SPE. The first steps identify a new plan and create a plan inception data file including but limited to the census of insured lives, the deceased previously insured, investor criteria, plan structure elements, owner attributes, base case illustration, life expectancy table and other pertinent information. Next, for of the three types of plans, the system provides periodic reports on the rates of returns on deceased lives, comparison of life expectancy to actual experience, and policy values. Additional steps are performed for a SOP. The computer system 100 computes a net amount at risk (“NAAR”) ratio to determine if a settlement investor has an option to purchase the endorsed policy. The system provides notice to both the Settlement Investor 116 and the COLI Owner 112 if their premium obligations are in arrears and/or past the policy grace period. Also, the system will notify the Settlement Investor 116 when its interest in the policy expires or is forfeited. Finally, the system provides electronic notice to the Settlement Investor 116 has an option to first right of refusal option to exercise

FIG. 16 (collectively FIGS. 16A-16E) is a block diagram of the Process to Forecast Performance 16 portion of the computer system 100. These steps of the system compute a forecast for either a SOP or a SPE program. These system steps parallel those in FIG. 8, but begin at different point in time and make available changes to plan structure, mortality assumptions, and other assumptions. The forecasts include the financial performance for both the policy owner and the settlement investor participating in the SOP or SPE transactions.

For the foregoing embodiments or any aspect thereof, there can be a computer-readable media tangibly embodying a program of instructions executable by a computer to perform the steps of: generating output with a computer system by processing input data and thereby producing at least one of the group including: an illustration including a party without an insurable interest in a life insured by a COLI (corporate-owned life insurance) policy, wherein the party receives an assignment of an interest in a policy benefit, a performance report of a transaction that corresponds to the assignment, and a forecast of at least one of earnings and cash flow of an assignor of the interest in the policy, and a forecast of cash flow of the party that receives the assignment, the forecasts using transaction experience data. In the method, the transaction may include a contribution of the policy to a Special Purpose Entity (SPE), the SPE having at least two investor/owners; the SPE performance report includes performance data corresponding to the owner of the policy; and the processing may include further producing at least one of the group including: a performance report of the transaction that includes performance data corresponding to at least one owner of the SPE, a forecast of a balance sheet of the SPE, a forecast of an income statement of the SPE, and a forecast of a cash flow statement of the SPE. This is representative of program instructions corresponding to other embodiments herein. The media can comprise at least one of a RAM, a ROM, a disk, an ASIC, and a PROM.

From a different perspective, in understanding the robust nature of the embodiments herein, consider an electronic transmission apparatus handling communications (signals) to facilitate in whole, or implement in part, an embodiment herein. Still another perspective is that of an electronic receiver apparatus handling communications (signals) to facilitate in whole, or implement in part, an embodiment herein. Viewed as a transmission system cooperating with a receiver system, respective computer systems can convey signals to enable a system as a whole to carry out the functionality illustrated herein.

In sum, appreciation is requested for the robust range of possibilities flowing from the core teaching herein. More broadly, however, the terms and expressions which have been employed herein are used as terms of teaching and not of limitation, and there is no intention, in the use of such terms and expressions, of excluding equivalents of the features shown and described, or portions thereof, it being recognized that various modifications are possible within the scope of the embodiments contemplated and suggested herein. Further, various embodiments are as described and suggested herein. Although the disclosure herein has been described with reference to specific embodiments, the disclosures are intended to be illustrative and are not intended to be limiting. Various modifications and applications may occur to those skilled in the art without departing from the true spirit and scope defined in the appended claims.

Thus, although only a few exemplary embodiments have been described in detail above, those skilled in the art will readily appreciate that many modifications are possible in the exemplary embodiments without materially departing from the novel teachings and advantages herein. Accordingly, all such modifications are intended to be included within the scope defined by claims. In the claims, means-plus-function claims are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment fastening wooden parts, a nail and a screw may be equivalent structures.

We claim:

1. A computer-aided method including:
generating output with a computer system by processing input data and thereby producing at least one of the group including:
an illustration including a party without an insurable interest in a life insured by a COLI (corporate-owned life insurance) policy, wherein the party receives an assignment of an interest in a policy benefit,
a performance report of a transaction that corresponds to the assignment, and
a forecast of at least one of earnings and cash flow of an assignor of the interest in the policy, and a forecast of cash flow of the party that receives the assignment, the forecasts using transaction experience data.

2. The method of claim 1, wherein the producing includes producing at least two of the group.

3. The method of claim 1, wherein the producing includes producing three of the group.

4. The method of claim 1, wherein:
the transaction includes a contribution of the policy to a Special Purpose Entity (SPE), the SPE having at least two investor/owners;
the SPE performance report includes performance data corresponding to the owner of the policy; and the processing includes further producing at least one of the group including:
a performance report of the transaction that includes performance data corresponding to at least one owner of the SPE,
a forecast of a balance sheet of the SPE,
a forecast of an income statement of the SPE, and
a forecast of a cash flow statement of the SPE.

5. The method of claim 4, wherein the further producing includes producing at least two of the group.

6. The method of claim 4, wherein the further producing includes producing at least three of the group.

7. The method of claim 4, wherein the further producing includes producing four of the group.

8. A computer-aided method including:
generating output with a computer system by processing input data and thereby producing an illustration including a party without an insurable interest in a life insured by a COLI (corporate-owned life insurance) policy, wherein the party receives an assignment of an interest in a policy benefit.

9. The method of claim 8, wherein the policy has a net amount at risk; and further including
determining the interest by the computer system with reference to net amount at risk.

10. The method of claim 9, wherein the interest is not more than the net amount at risk.

11. The method of claim 8, wherein the data includes an insured life's age and life expectancy, and targeted rate of return to the party; and further including computing a premium amount to pay for the interest, the premium amount included in the illustration.

12. The method of claim 8, wherein the data includes an insured life's age and life expectancy; and further including computing, with the computer system, a projected rate of return, the rate of return included in the illustration.

13. The method of claim 8, wherein the data includes an insured life's age and life expectancy, the interest, and a targeted rate of return to the party; and further including computing, with the computer system, a premium amount that is included in the illustration.

14. The method of claim 8, wherein the data includes an insured life's age and life expectancy, the interest, and a premium; and further including computing, with the computer system, a projected rate of return that is included in the illustration.

15. The method of claim 8, wherein the processing includes selecting at least one mortality table or life expectancy table for a computation corresponding to the illustration.

16. The method of claim 8, wherein the processing includes selecting of mortality tables or life expectancy tables for computations corresponding to the illustration.

17. The method of claim 8, further including accessing a selection of mortality tables or life expectancy tables in carrying out said producing of the illustration.

18. The method of claim 8, further including computing, with the computer system, a purchase price payable by a buyer of the policy, the computing of the purchase price carried out without underwriting.

19. The method of claim 8, further including computing, with the computer system, an internal rate of return (“IRR”) of the policy, the computing of the IRR being devoid of underwriting, in a transaction corresponding to the illustration.

20. The method of claim 10, further including computing, with the computer system, internal rate of return (“IRR”) of the policy, the computing of the IRR being devoid of underwriting, in a transaction corresponding to the illustration.

21. A computer-aided method including:
generating output with a computer system by processing input data and thereby producing a performance report of a transaction wherein a party, without an insurable interest in a life insured by a COLI (corporate-owned life insurance) policy, receives an assignment of an interest in a benefit of the policy.

22. The method of claim 21, wherein the policy has a net amount at risk; and further including
determining the interest by the computer system with reference to net amount at risk.

23. The method of claim 21, wherein the interest is not more than the net amount at risk.

24. The method of claim 21, wherein the processing includes selecting at least one mortality table or life expectancy table for a computation corresponding to the report.

25. The method of claim 21, wherein the processing includes selecting of mortality tables or life expectancy tables for computations corresponding to the report.

26. The method of claim 21, further including providing accessing a selection of mortality tables or life expectancy tables in carrying out said producing of the report.

27. The method of claim 21, further including computing, with the computer system, at least one of a mortality or life expectancy table based on at least two years of experience in the transaction.

28. The method of claim 21, further including providing, with the computer system, a selection of mortality tables or life expectancy tables in said producing the transaction report.

29. A computer-aided method including:
generating output with a computer system by processing input data and thereby producing at least one forecast of a transaction wherein a party, without an insurable interest in a life insured by a COLI (corporate-owned life insurance) policy, receives an assignment of an interest in a benefit of the policy.

30. The method of claim 29, wherein said at least one forecast includes a forecast of at least one of earnings and cash flow of an assignor of the interest in the policy, and a forecast of cash flow of the party that receives the assignment, the forecasts using transaction experience data.

31. The method of claim 30, wherein the policy has a net amount at risk; and further including
determining the interest by the computer system with reference to net amount at risk.

32. The method of claim 31, wherein the interest is not more than the net amount at risk.

33. The method of claim 30, wherein the data includes an insured life's age and life expectancy, and further including computing, with the computer system, a projected rate of return, the rate of return that is included in one of said forecasts.

34. The method of claim 30, wherein the data includes an insured life's age and life expectancy, interest, and a premium; and further including computing, with the computer system, a projected rate of return that is included in one of said forecasts.

35. The method of claim 30, wherein the processing includes selecting at least one mortality table or life expectancy table for a computation corresponding to one of said forecasts.

36. The method of claim 30, wherein the processing includes selecting of mortality tables or life expectancy tables for computations corresponding to one of said forecasts.

37. The method of claim 30, further including accessing a selection of mortality tables or life expectancy tables in the providing of one of said forecasts

38. The method of claim 30, further including providing, with the computer system, a selection of mortality tables or life expectancy tables in the providing of one of said forecasts

39. The method of claim 30, further including providing, with the computer system, a selection of a mortality table life or expectancy table in the providing of one of said forecasts

40. The method of claim 29, further including computing, with the computer system, the internal rate of return (“IRR”) of the party from a contribution to an SPE receiving a policy, the computing of the IRR being devoid of underwriting, in the providing said at least one forecast.

41. The method of claim 30, further including computing, with the computer system, the internal rate of return (“IRR”) of the party from a contribution to an SPE receiving a policy, the computing of the IRR being devoid of underwriting, in the providing one of said forecasts.

42. A computer-aided method including:
generating output with a computer system by processing input data and thereby producing an illustration including a party without an insurable interest in a life insured by a COLI (corporate-owned life insurance) policy, wherein the party receives an ownership interest in an SPE receiving a contribution of the policy.

43. The method of claim 42, wherein the policy has a net amount at risk; and further including
determining the interest by the computer system with reference to net amount at risk.

44. The method of claim 43, wherein the interest is not more than the net amount at risk.

45. The method of claim 42, wherein the data includes an insured life's age and life expectancy, and a targeted rate of return to the party; and further including computing a premium amount to pay for the interest, the premium amount included in the illustration.

46. The method of claim 42, wherein the data includes an insured life's age and life expectancy; and further including computing, with the computer system, a projected rate of return that is included in the illustration.

47. The method of claim 42, wherein the policy is a modified endowment contract (MEC).

48. The method of claim 42, wherein the illustration includes a contribution of the policy to the SPE.

49. The method of claim 48, wherein the policy is a modified endowment contract (MEC).

50. The method of claim 49, wherein the illustration includes a party, without an insurable interest in the life, with an interest in the SPE.

51. The method of claim 50, wherein the processing includes determining a special allocation of SPE revenues to an investor in the SPE

52. The method of claim 49, wherein the processing includes determining a special allocation of SPE principal to an investor in the SPE.

53. The method of claim 50, wherein the policy has a net amount at risk; and further including
determining an investor's contribution to the SPE by the computer system with reference to net amount at risk of the policy.

54. The method of claim 53, wherein the reference amount is not more than the net amount at risk.

55. The method of claim 42, wherein the data includes an insured life's age and life expectancy, the interest, and a targeted rate of return to the party and further including computing a premium amount that is included in the illustration.

56. The method of claim 55, wherein the policy is a modified endowment contract (MEC) policy, and wherein the processing includes computing a capital contribution to the SPE.

57. The method of claim 56, wherein the computing includes computing a special allocation of income to at least one owner of the SPE, the special allocation corresponding to an SPE ownership agreement.

58. The method of claim 42, wherein the processing includes computing an amount of SPE principal contribution by a non-COLI owner corresponding to the policy.

59. The method of claim 58, wherein the illustration includes the party without an insurable interest in a life insured by at least one other COLI policy, wherein the party receives an ownership interest in an SPE receiving a contribution of the at least one other policy.

60. The method of claim 42, wherein the processing includes selecting at least one mortality table or life expectancy table for a computation corresponding to the illustration.

61. The method of claim 42, wherein the processing includes selecting of mortality tables or life expectancy tables for computations corresponding to the illustration.

62. The method of claim 42, wherein the processing includes accessing mortality tables to form a projected age at death for the insured life, and producing, from the projected age, a time of projected terminal value or values of at least one investor in the SPE.

63. The method of claim 42, wherein the processing includes determining sensitivity of the SPE to different rates of death.

64. The method of claim 42, further including accessing a selection of mortality tables or life expectancy tables in said producing the illustration.

65. The method of claim 42, further including computing data, with the computer system, by using at least one mortality table or life expectancy table in a computation used to produce the illustration.

66. The method of claim 49, further including computing data, with the computer system, by using at least one mortality table or life expectancy table in a computation used to produce the illustration.

67. A computer-aided method including:
generating output with a computer system by processing input data and thereby producing a performance report of a transaction wherein a party, without an insurable interest in a life insured by a COLI (corporate-owned life insurance) policy, receives an ownership interest in an SPE receiving a contribution of the policy.

68. The method of claim 67, wherein the report includes a contribution of the policy to the SPE.

69. The method of claim 67, wherein the policy is a modified endowment contract (MEC).

70. The method of claim 67, wherein the report includes a party, without an insurable interest in the life, with an interest in the SPE.

71. The method of claim 67, wherein the processing includes determining a special allocation of SPE revenues to an investor in the SPE.

72. The method of claim 67 wherein the processing includes determining a special allocation of SPE principal to an investor in the SPE.

73. The method of claim 67, wherein the processing includes selecting at least one mortality table or life expectancy table for a corresponding to the report.

74. The method of claim 67, wherein the processing includes selecting of mortality tables or life expectancy tables for computations corresponding to the report.

75. The method of claim 67, further including accessing a selection of mortality tables or life expectancy tables in said producing the report.

76. The method of claim 67, further including computing, with the computer system, at least one of a mortality or life expectancy table based on at least two years of experience in said producing the report.

77. The method of claim 67, further including computing, with the computer system, at least one of a mortality or life expectancy table based on at least two years of experience in said producing the report.

78. The method of claim 67, further including providing, with the computer system, a selection of mortality tables or life expectancy tables in said producing the report.

79. A computer-aided method including:
generating output with a computer system by processing input data and thereby producing a forecast of a transaction wherein a party, without an insurable interest in a life insured by a COLI (corporate-owned life insurance) policy, receives an ownership interest in an SPE receiving a contribution of the policy, the forecast including a forecast of at least one of earnings and cash flow of the SPE receiving the policy, the forecasts using transaction experience data.

80. The method of claim 79, wherein the data includes an insured life's age and life expectancy, and further including computing, with the computer system, a projected rate of return that is included in the forecast.

81. The method of claim 79, wherein the forecast includes a contribution of the policy to the SPE.

82. The method of claim 79, wherein the policy is a modified endowment contract (MEC).

83. The method of claim 79, wherein the forecast includes a party, without an insurable interest in the life, with an interest in the SPE.

84. The method of claim 79, wherein the processing includes determining a special allocation of SPE revenues to an investor in the SPE.

85. The method of claim 79, wherein the processing includes determining a special allocation of SPE principal to an investor in the SPE.

86. The method of claim 79, wherein the processing includes selecting at least one mortality table or life expectancy table for a corresponding to the forecast.

87. The method of claim 79, wherein the processing includes selecting of mortality tables or life expectancy tables for computations corresponding to the forecast.

88. The method of claim 79, wherein the processing includes using mortality tables to project ages at death for the at least one insured life in producing a time of projected terminal value or values for the owner and an investor in the SPE, and thereby forecasting sensitivity of the SPE to different rates of death.

89. The method of claim 79, further including accessing a selection of mortality tables or life expectancy tables in said providing the forecast.

90. The method of claim 79, further including providing, with the computer system, a selection of mortality tables or life expectancy tables in said providing the forecast.

91. The method of claim 82, further including providing, with the computer system, a selection of mortality tables or life expectancy tables in said providing the forecast.

92. The method of claim 79, further including providing, with the computer system, a selection of a mortality table life or expectancy table in said providing the forecast.

93. The method of claim 82, further including providing, with the computer system, a selection of a mortality table life or expectancy table in said providing the forecast.

94. The method of claim 21, wherein the report includes a change in at least one of a right or an option with respect to the policy and subsequent to the assignment.

95. The method of claim 94, wherein the change is a change in a right.

96. The method of claim 94, wherein the change is a change in an option.

97. The method of claim 94, wherein the change is triggered by a premium obligation that is in arrears and within a grace period of the policy.

98. The method of claim 94, wherein the change is triggered by a premium obligation that is in arrears and past a grace period of the policy.

99. The method of claim 94, wherein the change is triggered by a premium that is unpaid as of at least one point in time specified in an agreement implementing the assignment agreement.

100. A method of claim 95, wherein the interest is a death benefit amount and the report includes a ratio of the interest and a net amount at risk corresponding to the policy.

101. The method of claim 100, wherein the processing includes forming a comparison of the ratio to a trigger ratio.

102. The method of claim 101, wherein the trigger ratio is determined by at least one of the assignment or an agreement between the party and an owner of the policy.

103. The method of claim 102, wherein the report includes a notice of an option of to purchase the policy, the notice corresponding to the trigger ratio.

104. The method of claim 94, wherein the report reflects that a premium obligation is in arrears and within a grace period of the policy.

105. The method of claim 94, wherein the report reflects that a premium obligation is in arrears and past the policy grace period.

106. The method of claim 94, wherein the report reflects that a premium is unpaid as of at least one point in time specified in an assignment agreement.

107. The method of claim 106, wherein the report includes a notice to the party and to an owner of the policy that the party's interest in the policy has terminated.

108. The method of claim 94, wherein an agreement implementing the assignment includes a stop loss provision with respect to the party with an assigned interest.

109. The method of claim 108, wherein the stop loss is a determined by the life surviving past at least one point time specified in the agreement.

110. The method of claim 108, wherein the report includes a notice that the stop loss provision has been met.

111. The method of claim 94, wherein the report includes a notice that the life has survived past at least one point in time.

112. The method of claim 94, wherein a policy assignment agreement gives a right of first refusal to purchase the policy.

113. The method of claim 94, wherein a policy assignment agreement gives a right of first refusal to purchase the policy with the assigned interest, according to a predetermined price or to a formula to compute the price.

114. The method of claim 94, wherein the right of first refusal to purchase arises from the policy owner's notice of the intent to sell or surrender the policy.

115. A method of claim 94, wherein the report includes a notice that a right of first refusal has been triggered.

116. A method of claim 115, wherein the interest is adjusted or terminated if the life survives past at least one point in time.

117. A method of claim 116, wherein the report is a notice that the assigned interest has been adjusted or terminated.
